(19) United States
(12) Patent Application Publication
(10) Pub. No.: US 2024/0377930 A1
(43) Pub. Date: Nov. 14, 2024

(54) IMAGE PROCESSING DEVICE

(71) Applicant: KYOCERA CORPORATION, Kyoto-shi, Kyoto (JP)

(72) Inventors: Hiroshi OKA, Kyoto-shi, Kyoto (JP); Kai SHIMIZU, Yokohama-shi, Kanagawa (JP); Masatoshi GO, Kirishima-shi, Kagoshima (JP)

(21) Appl. No.: 18/691,890

(22) PCT Filed: Oct. 29, 2021
(86) PCT No.: PCT/JP2021/040041

§ 371 Date: Mar. 14, 2024

(51) Int. Cl. G06F 3/0484

(52) U.S. Cl. CPC G06F 3/0484

(57) ABSTRACT

An image processing device includes an operation panel, a storage unit, and a controller. The operation panel is configured to accept an instruction from a user regarding image processing and be capable of displaying multiple history buttons containing information about previously completed image processing. The storage unit is configured to store image data handled in previous image processing. The controller allows access to corresponding image data inside the storage unit via a displayed history button, among the history buttons, under a condition that the history button can be displayed on the operation panel.

### TECHNICAL FIELD

The present invention relates to an image processing device. Image processing is, for example, printing of images, scanning of images, or communication relating to images.

### BACKGROUND OF INVENTION

A known image processing device is capable of displaying image processing history (for example, see Patent Literature 1 listed below). For example, the image processing device of Patent Literature 1 displays multiple buttons relating to image processing history on a touch panel. The buttons are arranged in order of the date and time when image processing was performed. Each button displays the type of image processing (copying, scanning, and so on), the image processing conditions (number of copies, color printing, double-sided printing, and so on), and the date and time the image processing was executed. When any one of the buttons is selected, the image processing conditions corresponding to that button are set as the conditions for the image processing to be performed. In this way, conditions that have been set in the past can be easily used.

### CITATION LIST

### Patent Literature

Patent Literature 1: Japanese Unexamined Patent Application Publication No. 2018-125687

### SUMMARY

In an aspect of the present disclosure, an image processing device includes an operation panel, a storage unit, and a controller. The operation panel is configured to accept an instruction from a user regarding image processing and is configured to be capable of displaying multiple history buttons containing information about previously completed image processing. The storage unit is configured to store image data handled in previous image processing. The controller is configured to allow access to corresponding image data inside the storage unit via a displayed history button, among the history buttons, under a condition that the history button can be displayed on the operation panel.

### BRIEF DESCRIPTION OF THE DRAWINGS

FIG. 1 is a block diagram illustrating an example of the configuration of an image processing device according to an embodiment.

FIG. 2 is a diagram illustrating an example of a home screen displayed on an operation panel of the image processing device in FIG. 1.

FIG. 3 is a diagram illustrating an example of a history use screen to which the home screen in FIG. 2 transitions.

FIG. 4 is a schematic diagram for describing generation and deletion of image data corresponding to history buttons contained in the home screen in FIG. 2.

FIG. 5 is a schematic diagram for describing image data corresponding to the history buttons from the viewpoint of an access method.

FIG. 6 is a schematic diagram illustrating an example of the configuration of data stored in a storage unit of the image processing device in FIG. 1.

FIG. 7 is a schematic diagram illustrating an example of content held by processing information contained in the data in FIG. 6.

FIG. 8 is a flowchart illustrating an example of the procedure of main processing performed by the image processing device in FIG. 1.

FIG. 9 is a flowchart connected to the flowchart illustrated in FIG. 8.

FIG. 10 is a schematic diagram illustrating a display example of history buttons for when a user has been authenticated.

FIG. 11 is a schematic diagram illustrating a display example of history buttons for when a user has not been authenticated.

FIG. 12 is a schematic diagram illustrating another display example as an alternative to the display example in FIG. 10.

FIG. 13 is a schematic diagram for describing an example of a mode of accessing image data corresponding to the display example in FIG. 12.

FIG. 14 is a diagram illustrating an example of a screen displayed in the example in

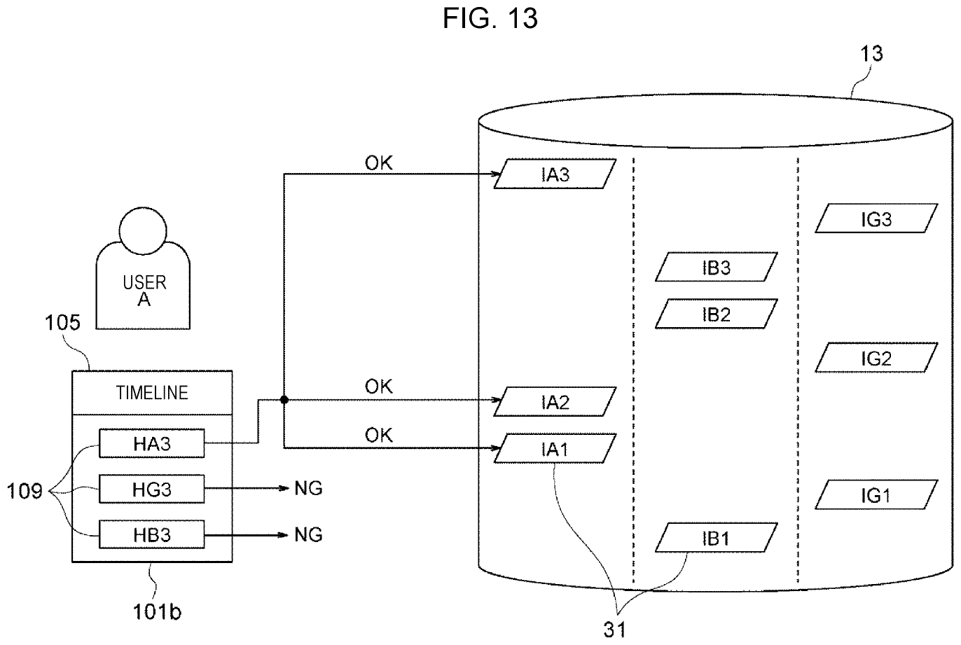

FIG. 13.

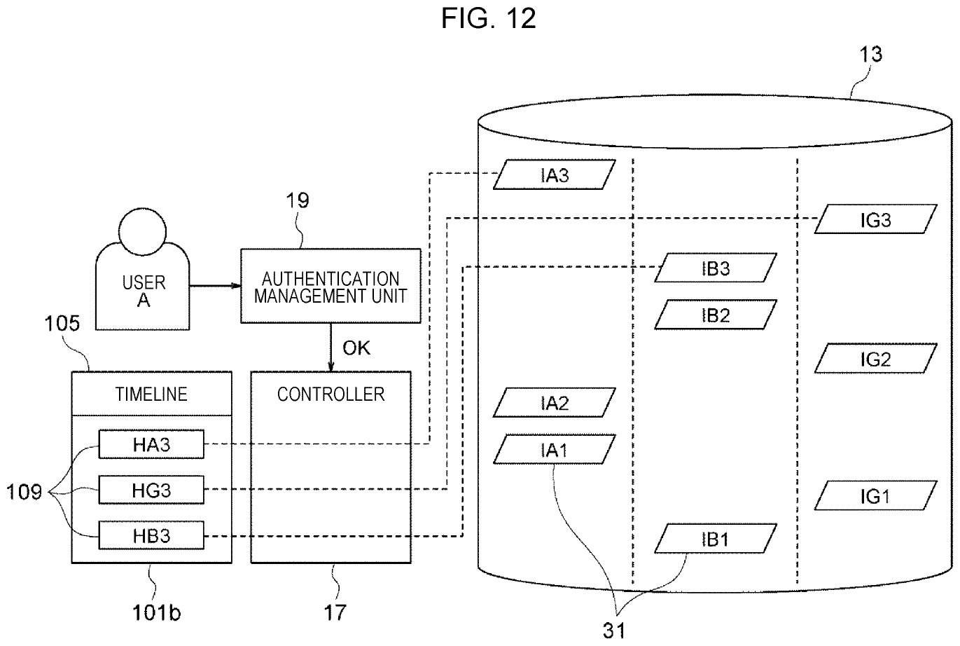

FIG. 15 is a schematic diagram for describing another example of a mode of accessing image data corresponding to the display example in FIG. 12.

FIG. 16 is a schematic diagram illustrating an example of a table used in authentication.

FIG. 17 is a schematic diagram illustrating an example of data for accessing information corresponding to a user.

FIG. 18 is a schematic diagram illustrating another example of data for accessing information corresponding to a user.

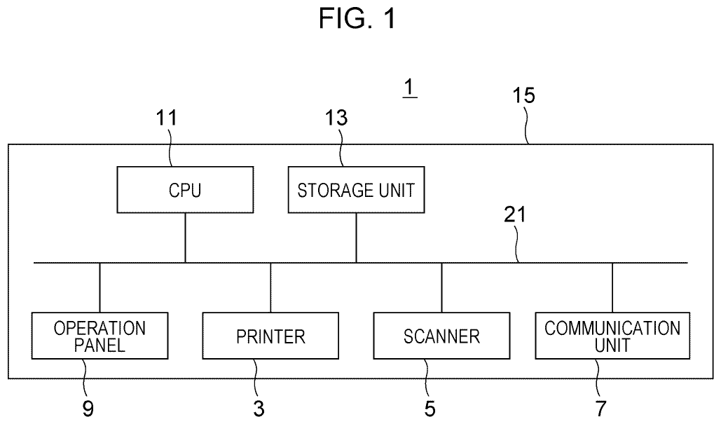

FIG. 19 is a flowchart illustrating an example of the procedure of authentication processing performed by the image processing device in FIG. 1.

FIG. 20 is a flowchart illustrating an example of the procedure of processing performed by the image processing device in FIG. 1 when a history button is operated.

### DESCRIPTION OF EMBODIMENTS (Overview of Image Processing Device)

FIG. 1 is a block diagram illustrating the configuration of an image processing device 1 according to an embodiment.

The image processing device 1 is configured as a multifunction machine and includes, for example, the following sections. A printer 3 that performs printing. A scanner 5 that scans images. A communication unit 7 that communicates with the outside. An operation panel 9 that accepts operations from a user. A central processing unit (CPU) 11 that performs various operations. A storage unit 13 that stores various information.

The operation panel 9 includes a touch panel. The operation panel 9 may include operation targets other than the touch panel such as physical buttons. However in the description of the embodiments, the description may be made with the assumption that the operation panel 9 includes only a touch panel.

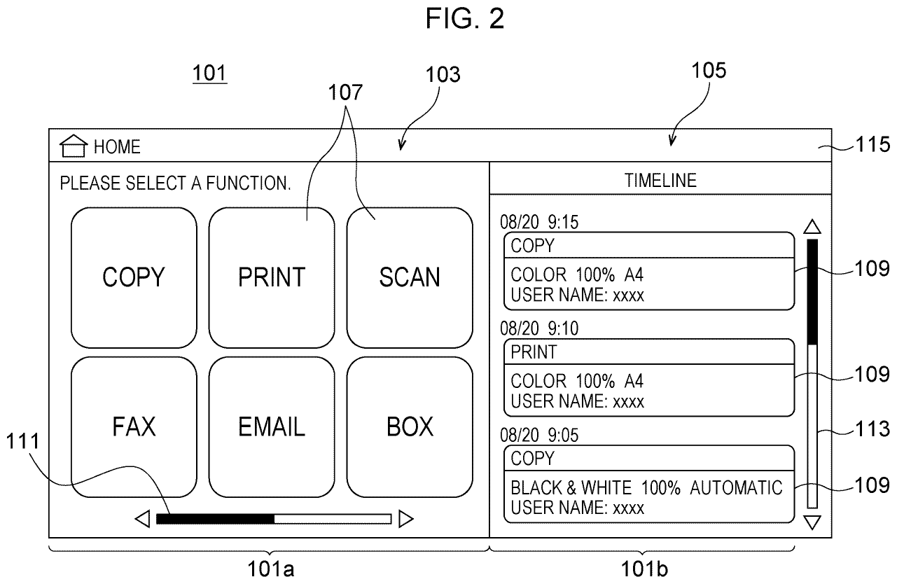

FIG. 2 is a diagram illustrating an example of a home screen 101 displayed on the operation panel 9.

The home screen 101 is, for example, a screen that is displayed when a user begins using the image processing device 1. From another perspective, the home screen 101 is a screen that is launched when power to the image processing device 1 is turned on, when the image processing device 1 is restored from sleep mode, and/or when the user is successfully authenticated by the image processing device 1.

The home screen 101 includes, for example, a main display region 101a and a timeline display region 101b. The main display region 101a displays a partial region out of a main region 103. The range that the partial region occupies out of the main region 103 may be indicated by a scroll bar 111. In addition, the timeline display region 101b displays a partial region out of a timeline region 105. The range occupied by the partial region out of the timeline region 105 may be indicated by a scroll bar 113.

The main region 103 includes multiple function buttons 107. The multiple function buttons 107 are for selecting any one function from among different functions (image processing functions from another perspective). The function buttons 107 display function information corresponding to their functions, “Copy”, “print”, “scan”, “fax” (facsimile), “email”, and “box” are illustrated as examples of functions in FIG. 2. When a prescribed operation (for example, a single touch (for example, a tap)) is performed on any of the function buttons 107, for example, the screen displayed on the operation panel 9 switches to a screen for performing operations related to the function corresponding to that function button 107. Operations relating to the function are, for example, an operation for executing image processing and an operation for setting conditions for the image processing (for example, the paper size when making a copy).

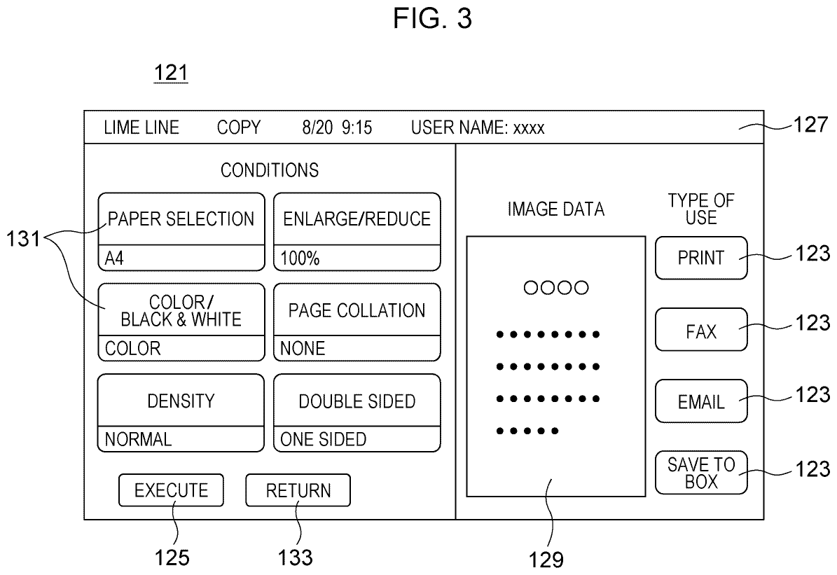

The timeline region 105 includes multiple history buttons 109. Each history button 109 contains (displays) information regarding image processing (function) performed in the past. In FIG. 2, the date and time when the image processing was performed, the type of image processing (“copy” or “print” is illustrated in FIG. 2), the conditions of image processing (“color”, “black & white”, and so on are illustrated in FIG. 2), and the user name of the user who performed the image processing (a string of characters schematically illustrated as “xxxx” is illustrated in FIG. 2) are illustrated as examples of image processing information displayed on the history buttons 109. When a prescribed operation (for example. a single touch (for example, a tap)) is performed on any one of the history buttons 109, the screen displayed on the operation panel 9 switches to a history use screen 121 (FIG. 3), for example. The history use screen 121 is for allowing history information corresponding to that history button 109 to be used.

FIG. 3 is a diagram illustrating an example of the history use screen 121 displayed on the operation panel 9). More precisely, an example history use screen 121 for when the history button 109 positioned uppermost, among the three history buttons 109 illustrated in FIG. 2, is selected is illustrated.

The history use screen 121 allows image data handled in the image processing corresponding to the selected history button 109 to be used. For example, the history use screen 121 includes multiple use buttons 123 that allow selection of any one of the different functions (image processing). Each use button 123 displays function information for the corresponding function. In FIG. 3, “print”, “fax”, “email”, and “save to box” are illustrated as examples of functions (types of use). When a prescribed operation (for example, a single touch (for example, a tap)) is performed on any of the use buttons 123, the image processing corresponding to the touched use button 123 is selected. When a prescribed operation (for example, a single touch (for example, a tap)) is performed on an execute button 125, image processing corresponding to the selected type of use is performed on image data corresponding to the history button 109 selected on the home screen 101.

Thus, in this embodiment, image data handled in image processing that has been completed in the past can be accessed via the history buttons 109. In this way, user convenience is improved. For example, image data handled in the past can be easily used in new image processing. At this time, a different type of image processing from the past image processing may be possible. For example, image data obtained by performing “scanning” may be used in “printing”. As an example of new image processing, image processing that is the same type of image processing as the past image processing may be performed under different processing conditions. For example, image data from “color” printing may be used in “black & white” printing.

The image processing device 1 may have or not have a function of identifying users (and a function of authenticating users) (Unless otherwise noted and unless any contradictions arise, “user” is assumed to include user groups. The same applies hereafter.). In order to simplify the description, for convenience, an embodiment irrespective of the presence or absence of such an identification function and such an authentication function will be referred to as a First Embodiment, and an embodiment in which the presence of such an authentication function is assumed will be referred to as a Second Embodiment, and the embodiments will be described in this order. However, for convenience, information, configurations, and operations with the assumption that the image processing device 1 has a function of identifying (and authenticating) users may be referred to even in the description of the First Embodiment.

### First Embodiment

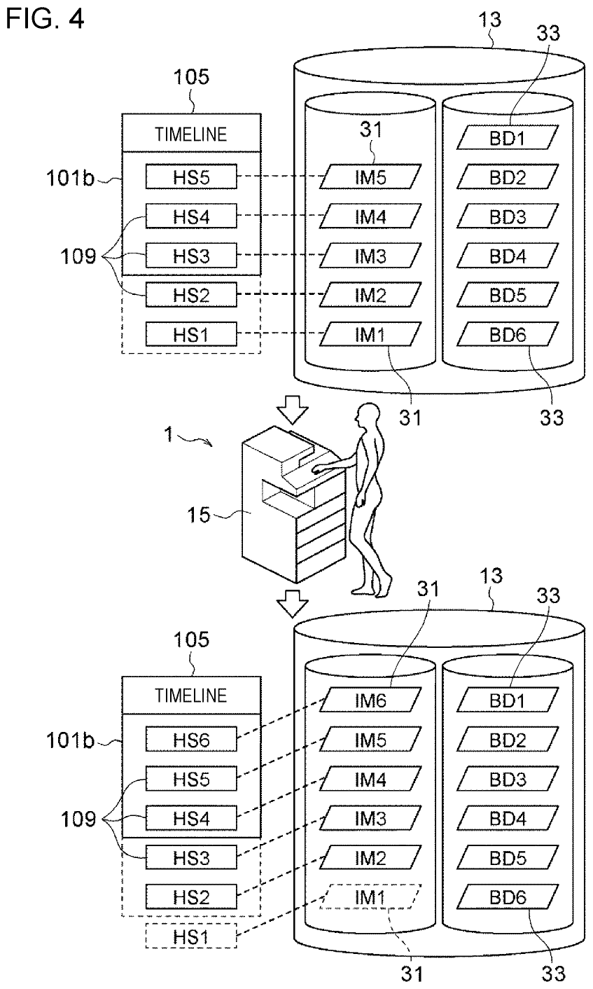

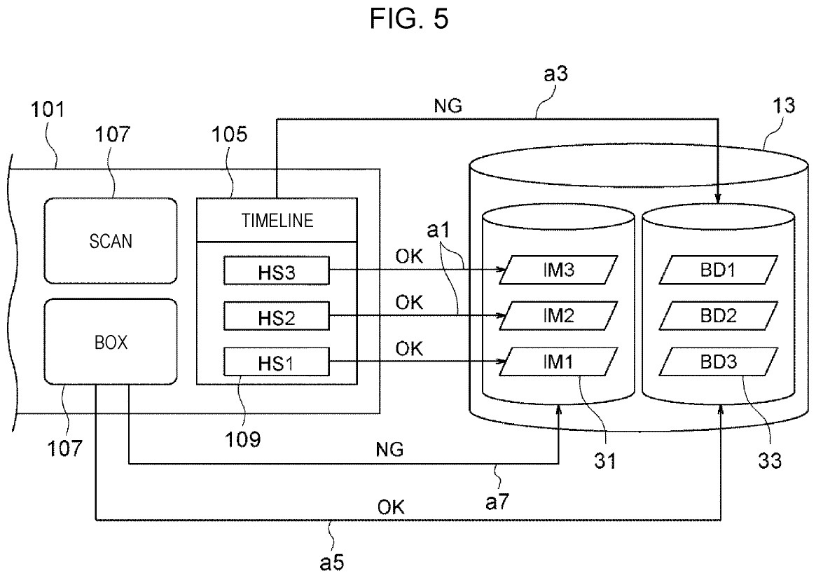

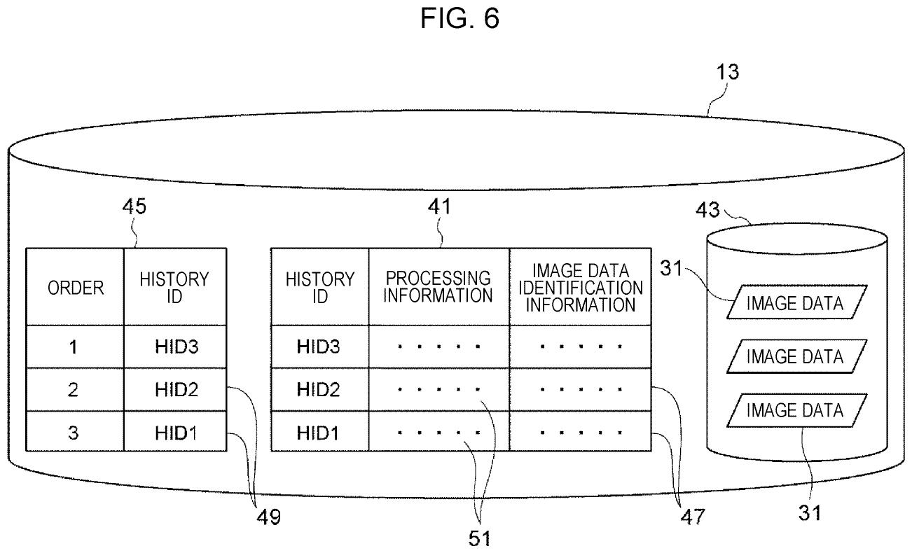

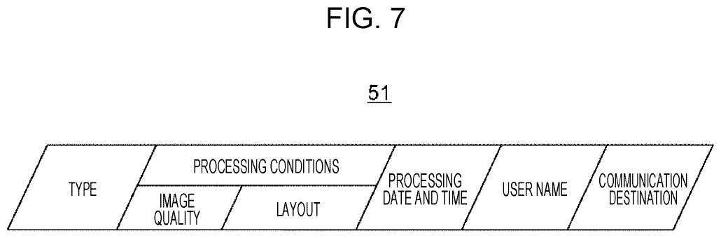

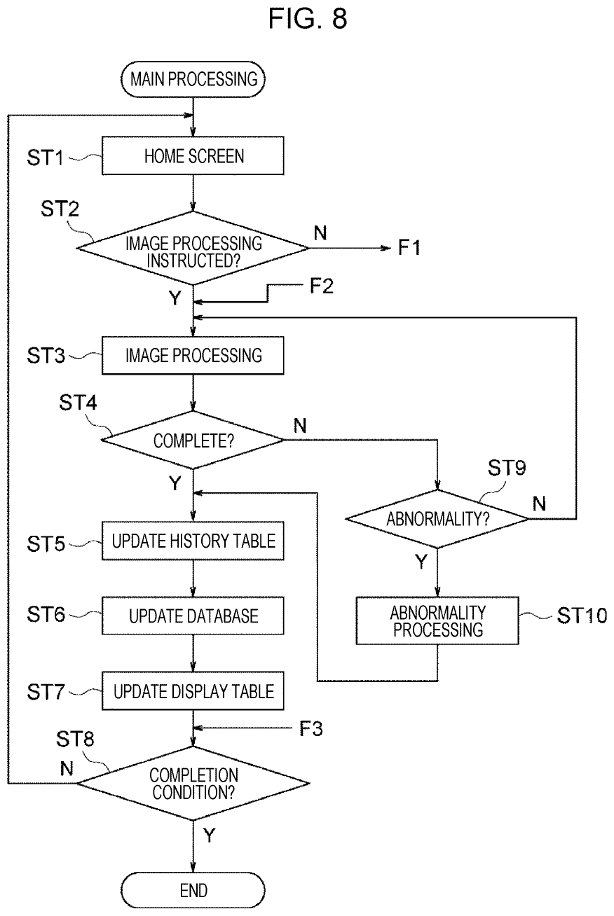

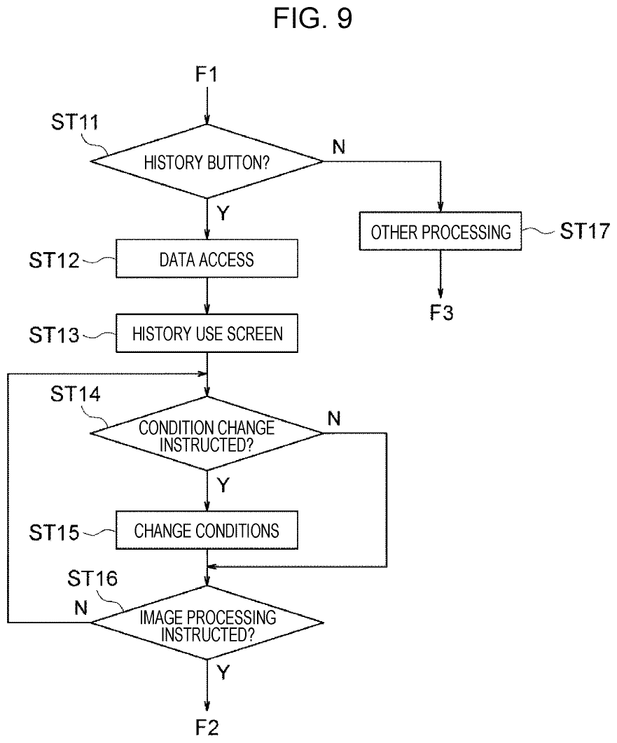

Hereafter, the image processing device 1 according to the First Embodiment will be briefly described in the following order.
1.1. Terminology, etc.
1.2. Configuration of Image Processing Device 1 (FIG. 1)
1.3. Operation of Image Processing Device 1 Relating to Home Screen 101 (FIG. 2)
1.4. Operation of Image Processing Device 1 Relating to History Use Screen 121 (FIG. 3)
1.5. Image Data Corresponding to History Buttons 109 (FIGS. 4 and 5)
1.6. Configuration of Data Relating to History Buttons 109 (FIGS. 6 and 7)
1.7. Example of Procedure of Processing Executed by Image Processing Device 1 (FIGS. 8 and 9)
1.8. Summary of First Embodiment

### 1.1. Terminology, etc.

An “image” may contain only text, “Image data” may be in various formats, for example, may be in a vector format or a raster format. In the description of the embodiments, “image” and “image data” are not always strictly distinguished from each other for the sake of convenience.

“Image data” may be converted to other formats as appropriate while image processing is being performed. For example, image data may be in different formats when stored in the image processing device 1 and when image processing (for example, printing or faxing) is performed. However, in the description of the embodiments, for convenience, description of such format conversions may be omitted and the image data before and after conversion may be described as being identical. The image data may be altered such that the quality of the image is changed or a portion of the image is cropped, for example, when image processing is performed. In such cases, the description of the embodiments may not distinguish between the image data before and after being altered for the sake of convenience.

The information displayed in the various areas of the various screens of the operation panel 9 (for example, the history buttons 109) may be displayed in the form of text and/or symbol images. In the description of the embodiments, for example, when information is displayed on the operation panel 9 or when an area (button, etc.) displayed on the operation panel 9 contains information, the information may be displayed in the form of text and/or symbol images so long as there are no particular inconsistencies and so on. For example, in addition to the history buttons 109, example of areas where information is displayed include the function buttons 107, the use buttons 123, the execute button 125, settings buttons 131 (described below), a return button 133 (described below), the regions around these buttons, and title bars 115 and 127 (described below).

“Text” may refer to, for example, information displayed as a string of characters and/or information displayed based on text data. Therefore, for example, text may be a string of characters displayed based on image data, or may be a symbol or only one character displayed based on text data. A “symbol image” may refer to, for example, information displayed as a symbol or graphic and/or information displayed based on image data. Therefore, for example, a symbol image may be a symbol displayed based on text data, or may be one or more characters displayed based on image data. As understood from the above description, text and symbol images may be partially overlapping classifications.

The “buttons” displayed on the operation panel 9 do not need to resemble physical buttons. For example, a button may be indicated only by text and/or a symbol image and does not need to have a border surrounding the text and/or symbol image. From another perspective, for example, the boundary between the region where a user's operation is detected and the surrounding region does not need to be represented by an enclosing line or a difference in color.

In the description of the embodiments, for convenience, terms indicating specific modes such as “tap,” “double tap,” and “long tap” may be used to describe operations performed on the operation panel 9. However, these terms may be generically conceptualized as “prescribed operations”.

### 1.2. Configuration of Image Processing Device

The image processing device 1 illustrated in FIG. 1 includes the operation panel 9 and is configured to be capable of performing one or more types of image processing. The specific configurations used may be any of various configurations, and, for example, known configurations may be used except for configurations relating to the history buttons 109. In this embodiment, as has already been mentioned, the printer 3, the scanner 5, and the communication unit 7 are provided as configurations for performing image processing. Modes different from this embodiment include, for example, a mode including only one out of the printer 3 and scanner 5, and a mode not including the communication unit 7. The configurations of the components (3, 5, 7, 9, 11, and 13) of the image processing device 1 may also be any of various configurations, for example, may be known configurations with the exception of configurations related to the history buttons 109.

The image processing device 1 includes, for example, a housing 15 that houses the various previously mentioned components (3, 5, 7, 9, 11, and 13). The size and shape of the image processing device 1 (housing 15 from another perspective) may be chosen as appropriate. For example, the image processing device 1 may be of such a size (mass) as to be able to be carried by one person such as a home-use multifunction machine or printer, or may be of such as size (mass) as to not able to be carried by one person such as a commercial-use multifunction machine or printer. FIG. 4 described below schematically illustrates the exterior of a commercial multifunction machine as an example of the exterior of the image processing device 1. The method of operation (or social role from another perspective) of the image

processing device 1 may be chosen as appropriate. For example, the image processing device 1 may be placed in a home for domestic or personal use, may be placed in a company for use by specific users and multiple users, or may be placed in a store such as a convenience store for use by an unspecified number of users. When the image processing device 1 is intended for use by an unspecified number of users, the image processing device 1 may authenticate a user and allow access only to image data related to that user. For a description of this operation, refer to the description of the Second Embodiment.

The configuration of the printer 3 may be chosen as appropriate. For example, the printer 3 may be configured to perform printing on paper (sheet paper from another perspective) disposed in a tray, which is not illustrated, and eject the paper after printing. The printer 3 may include only one tray or multiple trays. Multiple trays, for example, contribute to accommodating paper of different sizes. From another perspective, the printer 3 may have or not have a function of selecting the paper size. In the description of this embodiment, the former is taken as an example. The printer 3 may be configured to be capable of printing in color (and monochrome and grayscale), may be configured to be capable of printing only in grayscale (and monochrome), or may be configured to be capable of printing only in monochrome. In the description of this embodiment, a configuration capable of printing in color is taken as an example.

For example, the printer 3 may be an inkjet printer that prints by ejecting ink, a thermal printer that prints by heating thermal paper or an ink ribbon, or an electrophotographic printer (for example, a laser printer) that transfers toner attached to a photoreceptive medium irradiated with light. The inkjet printer may be a piezoelectric printer in which pressure is applied to the ink by a piezoelectric body, or a thermal printer in which pressure is applied to ink by bubbles created in ink to which heat is applied. For example, the printer 3 may be a line printer in which the head has a length that spans the width of the paper (in a direction that intersects a paper transport direction), or may be a serial printer in which the head moves in the width direction of the paper.

Although not specifically illustrated, for example, the scanner 5 performs scanning by capturing an image of a document placed on a document glass by using multiple image-capturing elements that move along the document glass under the document glass.

The communication unit 7 realizes communication between the image processing device 1 and other devices. Examples of other devices include personal computers (PCs). mobile terminals (for example, smartphones), other image processing devices, and servers. Examples of servers include file servers, mail servers, and web servers. Communication may be performed directly with other devices or indirectly over a network. Examples of networks include telephone networks, the Internet, private networks, and local area networks (LANs). The communication may be wired communication, wireless communication, short-range communication, or long-range communication.

The image processing device 1 may be configured to be capable of performing any one or more of the various types of communication described above. In the description of this embodiment, a mode in which the image processing device 1 can perform various types of communication as described above will be taken as an example. Although not specifically illustrated, the communication unit 7 includes various components for realizing the various types of communication described above. The communication unit 7 may be considered to include only a hardware configuration (for example, a connector, an antenna, an amplifier, a filter, and a radio-frequency (RF) circuit), or may be considered to include a software configuration (a functional unit created by a CPU executing a program) in addition to the hardware configuration.

The operation panel 9 includes a touch panel, as already mentioned. Although not specifically illustrated, the touch panel includes a display device and a position input device that overlaps a screen of the display device. The configurations of the display device and the position input device may be chosen as appropriate.

For example, the display device may be constituted by a liquid crystal display or an electroluminescence (EL) display. These displays contain a relatively large number of regularly arranged pixels and can display images containing any shapes based on image data. The display device may be capable of displaying color images, may be capable of displaying only grayscale images (and monochrome images), or may be capable of displaying only monochrome images (binary images).

In addition, for example, the position input device may be an electrostatic input device or a pressure sensitive position input device. An electrostatic position input device detect changes in the electrostatic capacitance of the screen and/or the vicinity thereof due to contact or proximity of a finger or pen. A pressure-sensitive position input device detects pressure exerted on the screen. In addition, the position input device may utilize surface acoustic waves, infrared light, or electromagnetic induction. The position input device may require or not require a dedicated pen.

In the description of this embodiment, for convenience, operations performed on the operation panel 9 (operations performed on software-like buttons and so on) may be described under the assumption that contact is made. However, as understood from the above description, an operation may be detected without contact being made.

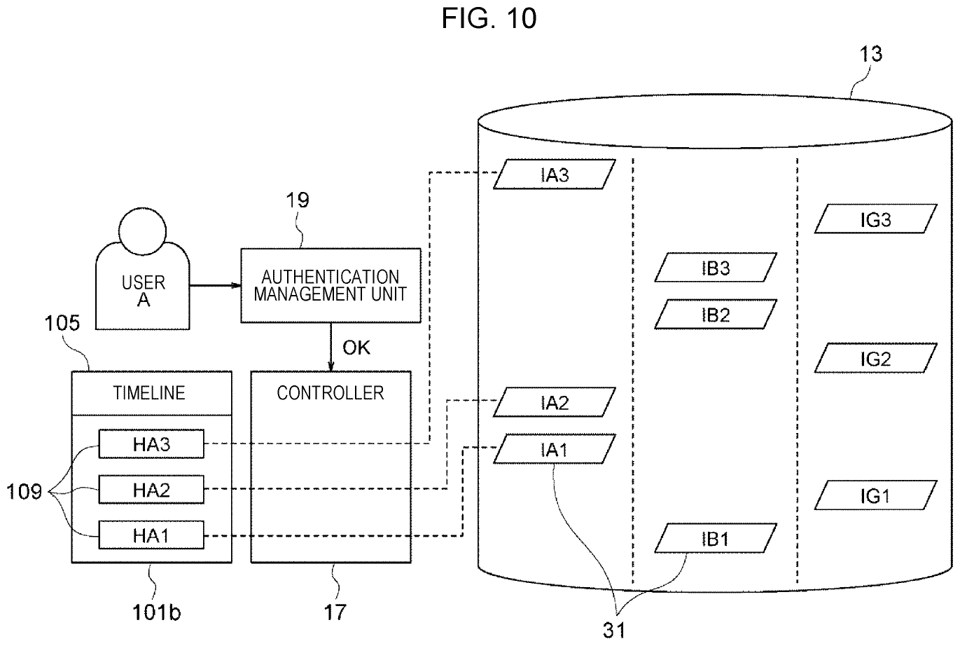

The CPU 11 creates a functional unit that executes various types of processing by executing programs stored in the storage unit 13. An example of such a functional unit is a controller 17 (refer to FIG. 10, which is a drawing for describing a Second Embodiment). The controller 17 controls operation of the printer 3, the scanner 5, the communication unit 7, and the operation panel 9. In addition to the part created by the CPU 11, the controller 17 may also include logic circuits configured to perform only certain operations.

Although not specifically illustrated, the storage unit 13 includes various types of memory such as a read only memory (ROM), a random access memory (RAM), and an auxiliary storage device. The combination of the CPU 11 and the storage unit 13 may be regarded as a computer. The program that the above-mentioned CPU 11 uses to build the controller 17 is stored, for example, in the ROM and/or auxiliary storage device of the storage unit 13.

The various components (3, 5, 7, 9, 11, and 13) described above are connected to each other by a bus 21, for example. In FIG. 1, all the components are schematically connected to a single bus 21. In an actual product, multiple buses may be connected in any appropriate manner. For example, address buses, data buses, and control buses may be provided. Crossbar switches and/or link buses may also be used. An interface, which is not illustrated, may be interposed between the bus 21 and various components (3, 5, 7, and 9, and so on).

FIG. 1 is merely a schematic diagram. Therefore, for example, multiple CPUs and storage units (or controllers from another perspective) may be provided in a distributed manner. For example, a CPU (from another perspective, a controller that controls a corresponding component) in each component (3, 5, 7 and/or 9) and a higher-level CPU (a higher-level controller that controls the controllers in the individual components) may be provided. In such a case, the controller 17 may be viewed as a higher-level controller or the controller 17 may be viewed as a combination of the controllers of the individual components and a higher-level controller. As is understood from the above description, the controller 17 and the components (3, 5, 7, and/or 9 do not necessarily need to be clearly distinguishable from each other.

### 1.3 Operation of Image Processing Device Relating to Home Screen

The home screen 101 illustrated in FIG. 2 is displayed over the entire screen of the operation panel 9, for example. The home screen 101 may include (and display), for example, the main region 103, the timeline region 105, and the scroll bars 111 and 113, as previously described. In addition, the home screen 101 may include other appropriate sections such as the title bar 115 located at the top. Hereafter, a brief description will be given in the following order.
1.3.1. Operation of Image Processing Device 1 Relating to Main Region 103
1.3.2. Operation of Image Processing Device 1 Relating to Timeline Region 105 (Mainly Operations up to Transition to History use Screen 121)

### 1.3.1. Operation of Image Processing Device Relating to Main Region

The display mode of the main region 103 and the processing executed when any of the function buttons 107 is selected may be any of various display modes and processing, and, for example, may be the same as or similar to known display modes and processing.

In the example in FIG. 2, a partial region out of the main region 103 is displayed in the main display region 101a. as previously described. Unlike in the illustrated example, the entire main region 103 may be displayed in the main display region 101a. From another perspective, the multiple function buttons 107 may be provided in a number greater than the maximum number that can be simultaneously displayed (illustrated example) or less than the maximum number. In the mode in which a partial region out of the main region 103 is displayed in the main display region 101a, the direction in which the main region 103 is scrolled (left or right in the illustrated example) may be chosen as appropriate.

The number of function buttons 107 and the types of functions corresponding to the function buttons 107 may be set as desired. The number of function buttons 107 may be increased or decreased by the user. The function buttons 107 illustrated in FIG. 2 are described below:

Note that, hereafter, the function buttons 107 may be referred to using the text displayed inside the function buttons 107. This also applies to other buttons (use buttons 123 and so on).

“Copy” is for setting settings relating to and/or executing a function of printing images scanned by the scanner 5 using the printer 3 (copy function).

“Print” is, for example, for setting settings relating to and/or executing a function of printing images based on data stored on a recording medium (not illustrated) connected to the image processing device 1 using the printer 3. The storage medium is, for example, a universal serial bus (USB) memory. Note that in the description of the embodiments, unless otherwise noted or unless there are contradictions, the term “print” is not limited to referring to printing performed using the “print” function button 107. (For example, printing performed in response to reception of a print job from the outside may be included.) (The same applies to the “print” use button 123 described below.)

“Scan” is for setting settings related to and/or executing a function of saving images scanned by the scanner 5 as data. The storage destination is, for example, an auxiliary storage device (nonvolatile memory from another perspective) included in the storage unit 13, a storage medium connected to the image processing device 1, or another device that communicates with the image processing device 1 via the communication unit 7. Note that, in the description of embodiments, unless noted otherwise and unless there are any contradictions, the term “scan” is not limited to referring to scanning performed using the “scan” function button 107 (for example, scanning performed during copying may be included).

“Fax” is for setting settings relating to and/or executing faxing. When transmitting a fax, for example, an image of a document to be transmitted is scanned by the scanner 5, and the data of the scanned image is transmitted by the communication unit 7. When receiving a fax, for example, image data is received by the communication unit 7 and printing based on the received image data is performed by the printer 3.

“Email” is for setting settings relating to and/or executing electronic mail. In this function, for example, part or all of the contents of an email received by the communication unit 7 may be printed by the printer 3. And/or the data of an image scanned by the scanner 5 may be included in an email transmitted by the communication unit 7.

“Box” is, for example, for browsing information on any number of pieces of image data stored in the auxiliary storage device (from another perspective. nonvolatile memory) included in the storage unit 13, and for setting settings relating to and/or executing a function of performing image processing on selected image data. Image processing is, for example. printing, sending by fax, or sending by email.

As already mentioned, for example, when any of the function buttons 107 is tapped. the screen displayed on the operation panel 9 switches to a screen (not illustrated) for performing operations related to the function corresponding to that function button 107. For example, if “copy” is tapped, multiple buttons for setting processing conditions, a button for instructing execution of copying, and a button for returning to the home screen 101 are displayed. Refer to the description of FIG. 3 given below for the buttons for setting the processing conditions. Then, when the button for instructing execution is tapped, copying is executed. After that, when the button for returning to the home screen 101 is tapped, or once a certain amount of time has elapsed, the screen displayed on the operation panel 9 returns to the home screen 101.

In contrast to the above description, image processing (for example, copying) may be performed when the relevant function button 107 is tapped. The image processing conditions (for example, copying processing conditions) may be set on a dedicated screen for setting the processing conditions displayed in response to tapping a dedicated function button 107 for setting the processing conditions.

### 1.3.2. Operation of Image Processing Device Related to Timeline Region

The display mode of the timeline region 105 may be any of various display modes. and for example, may be the same as or similar to known display modes. However, at least some of the processing performed when a prescribed operation (for example, a tap) is performed on the history buttons 109 is different from known processing.

The position, shape, and area of the timeline display region 101b may be chosen as appropriate. In the example in FIG. 2, the timeline display region 101b is positioned on one side (the right-hand side in the illustrated example) in the horizontal direction of the rectangular home screen 101 (the entire screen of the operation panel 9 from another perspective), which has the horizontal direction as its longitudinal direction. The timeline display region 101b has a rectangular shape with the vertical direction being the longitudinal direction of its rectangular shape. The width of the timeline display region 101b is less than ½ or less than ⅓ the width of the home screen 101. The majority of the home screen 101, excluding the timeline display region 101b (for example, more than 80%), constitutes the main display region 101a.

In the example in FIG. 2, a portion of the timeline region 105 is displayed in the timeline display region 101b. as described previously. Unlike in the illustrated example, the entire timeline region 105 may be displayed in the timeline display region 101b. From another perspective, the multiple history buttons 109 may be provided in a number greater than the maximum number that can be simultaneously displayed (illustrated example) or provided in a number less than or equal to the maximum number. In the mode in which a partial region out of the timeline region 105 is displayed in the timeline display region 101b. the direction in which the timeline region 105 is scrolled is performed (up or down in the illustrated example) may be chosen as appropriate.

The multiple history buttons 109 are, for example, arranged in a single row in a prescribed direction in the order of the date and time image processing operations corresponding to the history buttons 109 were executed. The direction in which the multiple history buttons 109 are arranged may be chosen as appropriate. In the example in FIG. 2, the arrangement directions are the vertical direction of the home screen 101, the longitudinal direction of the timeline display region 101b. and the direction in which the timeline region 105 is scrolled. The multiple history buttons 109 may be arranged from one side to the other side in the arrangement direction (from top to bottom in the illustrated example), in order from newest to oldest, or may be switchable between from newest to oldest and from oldest to newest by performing prescribed an operation on the operation panel 9. In the description of this embodiment, for the sake of convenience, the history buttons 109 are assumed to be arranged in order from newest to oldest.

When image processing is executed via an operation performed on a function button 107 or when image processing is executed via an operation performed on a history button 109 (and use button 123 (FIG. 3)), a new history button 109 is added for that image processing. If image processing that led to the addition of a history button 109 is the same as new image processing that was performed via an operation performed on that history button 109, the history button 109 may be added anew, or the date and time of the executed image processing corresponding to the operated history button 109 may be updated (from another perspective. the display position of the history button 109 may be changed). The image processing operations here may be identical, for example, except for the date and time of execution. However, other differences may exist besides the date and time of execution. For image processing executed via an operation performed on a history button 109, unlike in the description of this embodiment, a history button 109 does not need to be added.

The types of image processing for which the history buttons 109 are generated may be set as appropriate. For example, even if the image processing device 1 has the six functions illustrated on the home screen 101, the history buttons 109 do not need to be generated for all of them. For example, the history buttons 109 may be generated only for image processing in which printing is performed by the image processing device 1, such as “copy” and “print” (and printing in “box”). In addition, the history buttons 109 may be generated only for image processing in which scanning is performed by the image processing device 1 such as “copy”. “scan”, “fax”, and “email”. The history buttons 109 may be generated only for image processing in which no communication takes place, for example, “copy”, “print” and “scan” (and printing in “box”).

For image processing that is performed by transmitting a signal including a print job, etc., from another device (for example, a PC) to the communication unit 7, the history buttons 109 may be added or not added. If a history button 109 is added, for example, a user who transmitted a print job from a PC to the image processing device 1 can reprint the job via the history button 109 when he or she observes a print failure in front of the image processing device 1. In the description of this embodiment, basically, description of the addition of the history buttons 109 with this type of image processing whose execution is instructed via communication with the outside is omitted. In a mode in which the history buttons 109 are added, in the description of this embodiment, so long as there are no contradictions or the like, an instruction for executing the image processing using a signal from the outside may be added to the location where an instruction for executing the image processing using the operation panel 9 is described.

The number of history buttons 109 provided in the timeline region 105 is limited to being no more than a prescribed upper limit. In other words, the number of history buttons 109 (including those displayed by scrolling) that can be displayed in the timeline display region 101b is limited to being no more than the prescribed upper limit. Thus, for example, when the history buttons 109 are added as described above, if an additional new history button 109 is to be added after the number of history buttons 109 has reached the upper limit, the oldest history button 109 will be deleted. In other words, the oldest history button 109 will not be displayable. Consequently, the image data associated with that history button 109 will be essentially inaccessible.

The specific value of the upper limit may be set as appropriate and is 5, 10, or 20, for example. The upper limit may be set by the manufacturer of the image processing device 1 and may be unchangeable by the administrator or user of the image processing device 1, or may be set by the administrator of the image processing device 1. In a mode where the display mode of the timeline region 105 can be made different for each user, the upper limit may be set by the user.

If the number of history buttons 109 has not reached the upper limit, the display mode may be any appropriate display mode. For example, only the number of history buttons 109 below the upper limit may be displayed, or dummy history buttons (for example, history buttons that do not display information thereinside) may be displayed together with the history buttons 109 so that in total the upper limit number of history buttons is displayed. In the former mode, the length of the timeline region 105 may vary or not vary in accordance with the number of history buttons 109.

The image processing device 1 may be capable of operating differently from the above description with respect to the addition, deletion, and arrangement of the history buttons 109. For example, by performing an operation (for example, a long tap or a double tap) on any history button 109 that is different from the operation performed when switching to the history use screen 121, deletion of that history button 109 may blocked, that history button 109 may be made to be always disposed above the most recent history button 109, or that history button 109 may be deleted. In the description of this embodiment, for the sake of conciseness of explanation and ease of understanding, the descriptions or wordings may assume that such operations are not performed.

The multiple history buttons 109 may, for example, have the same shape and size as each other (illustrated example), or may have different shapes and/or sizes from each other. An example of the latter is a mode in which the multiple history buttons 109 have different shapes and/or sizes from each other depending on the type of image processing (differences such as copying or scanning).

Each history button 109 contains (displays) information about the corresponding image processing. Examples of this information include, for example, the date and time the image processing was performed, the type of image processing, the conditions of the image processing, and the user name of the user who performed the image processing, as described previously. Other examples include communication destinations (sender and/or receiver) in the fax function and/or email function.

Information about image processing may include information about the image data handled in the image processing. Information about the image data includes, for example, the size of the image data, the type of image as determined by the image processing device 1 (for example, document or not document), and the name given to the image data by the image processing device 1. For the sake of convenience, in the description of this embodiment. description of information about image data as information about image processing is omitted.

Each history button 109 may display at least one or more pieces of information out of the various pieces of information about image processing (for example, date and time, type. processing conditions, and user name) described above. The conditions of the image processing include a variety of specific conditions, as exemplified in the description of FIG. 3 below. In a mode in which conditions of the image processing are displayed within the history buttons 109, the specific conditions that are displayed may be selected as appropriate. In FIG. 2, the color condition (“color” and “black & white” are given as examples), the magnification setting (“100%” is given as an example), and the paper condition (“A4” and “auto” are given as examples) are illustrated.

The history buttons 109 may contain the same type of image processing information (in other words, the items displayed on the history buttons 109), or may contain different types of image processing information from each other. For example, the types of information displayed on the history buttons 109 may vary depending on the type of image processing. More specifically, for example, a history button 109 in which the type of image processing is copying does not include an entry for displaying a communication destination, whereas a history button 109 in which the type of image processing is fax or email may include an entry for displaying the communication destination. ×1.4. Operation of Image Processing Device Relating to History Use Screen

The history use screen 121 illustrated in FIG. 3 may include (and display) the following, for example, in addition to the previously described use buttons 123 and execute button 125. The title bar 127 of the history use screen 121. A thumbnail 129 for checking the image data corresponding to the history button 109. One or more settings buttons 131 for checking and setting conditions and so on for image processing. The return button 133 for returning to the home screen 101. The settings buttons 131 may be used to check and set settings other than processing conditions (for example, the communication destination). However, hereafter, the processing conditions may be taken as examples unless otherwise noted.

The layout of the various sections described above may be set as appropriate, and FIG. 3 is merely one example. In the example in FIG. 3. generally speaking, a region in which multiple use buttons 123 are arranged, a region in which the thumbnail 129 is displayed, and a region in which multiple settings buttons 131 are arranged are provided. These three regions are arranged in the above order, from right to left.

The multiple use buttons 123 are provided in accordance with the type of image processing to be newly performed for the image data corresponding to the history button 109 selected on the home screen 101, as described previously. In FIG. 3, “print”, “fax”, “email”, and “save to box” are illustrated as examples of types of image processing. These types of image processing are, for example, the same as, similar to, or correspond to the types of image processing corresponding to the function buttons 107 on the home screen 101, except for the target image data. This is described more specifically below.

“Print” is for printing an image using the printer 3 based on the image data corresponding to the history button 109 selected on the home screen 101, “Fax” is for transmitting the image data corresponding to the history button 109 selected on the home screen 101 from the communication unit 7 via fax, “Email” is for transmitting the image data corresponding to the history button 109 selected on the home screen 101 from the communication unit 7 via email.

“Save to box” is for storing the image data corresponding to the history button 109 selected on the home screen 101 in the auxiliary storage device (from another perspective. nonvolatile memory) included in the storage unit 13 so as to be available via the “box” function on the home screen 101. The difference between image data stored so as to be available via the history buttons 109 and image data stored so as to be available via the box function is discussed below.

The thumbnail 129 is displayed based on the image data corresponding to the history button 109 selected on the home screen 101, for example. This display mode may be the same as or similar to, for example, the display of image data by data viewing software for PCs and the display of image data on a web page. Specifically, for example, pixel averaging may be performed so that the entire image based on the image data is displayed in the region allocated for the thumbnail 129. In addition, a portion of an image spanning multiple pages (for example, the first page) may be displayed, or a portion of a single image may be displayed (cropping may be performed).

Thus far, the feature that image data corresponding to the history buttons 109 may be used via the use buttons 123 and the execute button 125 has been discussed. The display of thumbnail 129 may also be regarded as an example of a method of using the image data corresponding to the history button 109. From another perspective, access to the image data via the history buttons 109 does not need to be via the use buttons 123 and the execute button 125.

The thumbnail 129 can also be displayed without accessing the corresponding image data when the history button 109 is selected. For example, when a new history button 109 is generated, image data for the thumbnail 129 may be generated in advance with a smaller data size relative to the original image data.

Multiple settings buttons 131 are provided so as to correspond to multiple setting items (for example, processing conditions), for example. When any of the settings buttons 131 is tapped, for example, a screen or window for setting the corresponding item is displayed on the operation panel 9. This allows, for example, the corresponding item to be changed from the current setting.

When any of the history buttons 109 is selected on the home screen 101 and the home screen 101 transitions to the history use screen 121 (immediately after the transition). the initial settings for the various setting items may be set as appropriate. For example, for image processing that is the same type as the image processing corresponding to the history button 109, the settings used when the image processing corresponding to the history button 109 was performed may be used as the initial settings. For other types of image processing as well, items that are the same as those in the type of image processing corresponding to the history button 109 may be set to the initial settings used when the image processing corresponding to the history button 109 was performed. For example, the processing conditions for copying illustrated in FIG. 3 can be used as the processing conditions for printing. For example, for items that are in another type of image processing but are not in the type of image processing corresponding to the history button 109, initial settings may be used that have been preset by the manufacturer, administrator, or user of the image processing device 1.

The number and types of settings buttons 131 (in other words, setting items) displayed on the history use screen 121 may vary, since the items that can be set (for example, processing conditions) vary depending on the type of image processing. For example, when any of the use buttons 123 is selected, only the settings buttons 131 corresponding to the items that can be set in the type of image processing corresponding to the selected use button 123 may be displayed. When any of the history buttons 109 is selected on the home screen 101 and the home screen 101 transitions to the history use screen 121, for example, the use button 123 corresponding to the type of image processing corresponding to the history button 109 may be automatically selected, or any pre-determined use button 123 may be automatically selected, and only the settings buttons 131 corresponding to the above selection may be displayed.

Unlike in the above description, the number and types of settings buttons 131 displayed do not need to change. In this case, for example, some of the settings buttons 131 may indicate that they cannot be set for the type of image processing corresponding to the selected use button 123, or operations on some of the settings buttons 131 may be disabled in accordance with the selected use button 123. Some setting items (for example, setting items that have a low probability of being changed) may be set on a screen other than the history use screen 121 (for example, a screen corresponding to not displayed function buttons 107 for settings provided on the home screen 101).

Each settings button 131 display information indicating the type of setting item corresponding to the button. Each settings button 131 may also display information indicating the setting status of the item corresponding to the button. In the illustrated example, the type of the setting item is displayed in the upper part of each settings button 131, and the current setting status of that item is displayed in the lower part of the settings button 131.

As understood from the previous description, the number and types of the settings buttons 131 may be chosen as appropriate. In FIG. 3, “paper selection”, “color/black & white”, “density”, “reduce/enlarge”, “page collation”, and “double sided” are illustrated as the settings buttons 131 when a history button 109 corresponding to copying has been selected. In the lower parts of the settings buttons 131, “A4”, “color”, “normal”, “100%”, “not set”, and “single sided” are illustrated as examples of the current settings for these items. Since these are typical settings, description thereof is omitted.

### 1.5. Image Data Corresponding to History Buttons

FIG. 4 is a schematic diagram for describing the generation and deletion of image data corresponding to the history buttons 109.

In the drawing in the upper part of FIG. 4, the timeline region 105 is schematically illustrated on the left side. Here, the timeline region 105 includes the maximum number of history buttons 109 that can be displayed (taken to be five for convenience) (with symbols such as “HS1” to “HS5” for convenience). Out of the history buttons 109, the three history buttons 109 surrounded by solid lines (“HS5” to “HS3”) are located in the timeline display region 101b. and the remaining two history buttons 109 surrounded by dotted lines (“HS2” and “HS1”) are located in a not-displayed region.

In addition, in the drawing in the upper part of FIG. 4, the storage unit 13 is schematically illustrated on the right side. The storage unit 13 stores, for example, the same number of pieces of image data 31 (with symbols such as “IM1” to “IM5” for convenience) as the maximum number of history buttons 109 that can be displayed. The image data 31 may be stored in either the RAM or auxiliary storage device in the storage unit 13. In other words, the image data 31 may be stored in either volatile memory or nonvolatile memory.

In the middle part of FIG. 4, a situation is schematically illustrated in which image processing is performed by a user performing an operation on the image processing device 1. For example, copying, printing, scanning, sending a fax, or sending an email is executed by operating the appropriate function button 107 on the home screen 101, or by operating the appropriate history button 109 on the home screen 101 and the appropriate use button 123 on the history use screen 121.

Thus, a new history button 109 “HS6” corresponding to the above image processing is added (made displayable), as illustrated in the drawing in the lower part of FIG. 4. The oldest history button 109 “HS1” is deleted (made not displayable), as indicated by the dotted line. At this time, the image data 31 (“IM6”) handled in the above image processing is newly stored in storage unit 13. In other words, the image data 31 “IM6” corresponding to the history button 109 “HS6” is newly stored. In addition, the image data 31 “IM1” corresponding to the history button 109 “HS1” is deleted.

More strictly speaking, the image data 31 “IM6” can be stored at least in RAM prior to image processing in order to perform image processing based on that data, “Newly stored” in the above description may refer to, for example, being stored prior to image processing as described above, may refer to being newly stored separate from being stored prior to image processing, or may refer to storage of information (for example, an address) about the image data 31 “IM6” in a suitable table so as to be available via the appropriate history button 109. Deletion of the image data 31 “IM1” may refer to deletion of the image data 31 or may refer to the deletion of information about the image data 31 “IM1” (for example, address) from the appropriate table so as to be no longer available via the history button 109.

Deletion of the image data 31 “IM1” may mean writing other information over the storage area where the image data 31 was stored or initializing the storage area. In other words, deletion of the image data 31 may make the image data 31 unrecoverable. Deletion of the image data 31 may also include deleting the information of the address of the storage area where the image data 31 is stored. In other words, although the image data 31 cannot be accessed by an operation performed by the user on the image processing device 1, there is a possibility that the image data 31 could be recovered by a specialist. The image data 31 “IM6” may be stored in the storage area where the image data 31 “IM1” was stored or in a different storage area.

As described above, the image data 31 corresponding to the history button 109 is basically automatically saved anew at the time of image processing. From another perspective, the image data 31 is basically associated with the history button 109 when the image processing is carried out. From yet another perspective, the image data 31 is basically stored temporarily. From yet another perspective, the image data 31 is different from image data (for example, image data 33 described below for the box function) that is saved or deleted by an operation in which the saving or deletion of the image data is directly intended.

As already mentioned, when image processing is performed by selecting a history button 109, a new history button 109 may coexist in the timeline region 105 with the selected history button 109, for example, (except when the selected history button 109 is deleted due to the maximum number being reached), or the selected history button 109 may be displaced as though replaced by the new history button 109. In the former case, for example, two or more identical pieces of image data corresponding to two or more history buttons 109 may coexist, or one piece of image data 31 may be associated with two or more history buttons 109 (no new storage is required).

As already mentioned, any of the history buttons 109 may be deleted by an operation performed by the user. At this time, the image data 31 corresponding to the deleted history button 109 may also be deleted. In addition, as previously mentioned, deletion of any history button 109 by a user operation may be blocked. In this case, the image data 31 corresponding to that history button 109 may continue to be stored as long as the history button 109 can be displayed.

The image data 31 may be stored in either volatile memory or nonvolatile memory. as previously mentioned. In a case in which the image data 31 is stored in volatile memory. the image data 31 may be deleted, for example, when the power of the image processing device 1 is turned off (or shifted to sleep mode). Accordingly, the timeline region 105 may also be initialized the next time the image processing device 1 is turned on (or restored from sleep mode). In a case in which the image data 31 is stored in nonvolatile memory, for example, the continuity of the timeline region 105 before and after the power is turned off and on (before and after sleep mode) may be maintained unless a prescribed initialization operation is performed. However, the image data 31 stored in nonvolatile memory may be deleted when the power is turned off (or shifted to sleep mode), and the timeline region 105 may be accordingly initialized.

In FIG. 4, multiple pieces of image data 33 (denoted by symbols “DB1” to “DB6” for convenience) used by the “box” function button 107 are illustrated for comparison with the image data 31. Unlike the image data 31, the image data 33 is essentially stored independently of updating of the history buttons 109 that can be displayed. From another perspective, the image data 33 is not automatically stored when copying or printing is performed, for example, but is stored when an operation is performed to store the image data 33 in the storage unit 13. Examples of such operations include an operation performed on the “scan” function button 107 and an operation performed on the “save to box” use button 123. The image data 33 basically remains stored (is not automatically deleted) unless the image data 33 is deleted, for example, by an operation being performed on the “box” function button 107.

FIG. 5 is a schematic diagram for describing the image data 31 from the viewpoint of access methods.

On the left side of FIG. 5, a portion of the home screen 101 is illustrated in a more schematic manner than in FIG. 2. Here, timeline region 105 includes the history buttons 109 “HS3” to “HS1”. Here, whether or not the history buttons 109 are located in the timeline display region 101b is not considered. The storage unit 13 is schematically illustrated on the right side of FIG. 5, similarly to as in FIG. 4. However, the number of pieces of image data 31 (“IM1” to “IM3”) corresponding to the history buttons 109 and the number of pieces of image data 33 (“BD1” to “BD3”) corresponding to the box function are illustrated in smaller numbers than in FIG. 4.

As previously described, and as indicated by arrows al with the word “OK” attached, the controller 17 allow access to the image data 31 via operations performed on the history buttons 109 (For example, reading of the image data 31. Same applies to description of FIG. 5). On the other hand, as indicated by an arrow a3 with the word “NG” attached, the controller 17 does not allow access to the image data 33 via operations performed, for example, on the history buttons 109.

As indicated by an arrow a5 with the word “OK” attached, the controller 17 allows access to the image data 33 via an operation performed on the “box” function button 107. On the other hand, as indicated by an arrow a7 with the word “NG” attached, the controller 17 blocks access to the image data 31 via an operation performed on the “box” function button 107, for example.

Thus, the image data 31 corresponding to the history buttons 109 and the image data 33 related to the box function differ from each other in terms of the operations used to access them. In other words, the image data 31 corresponding to the history buttons 109 is not accessed (displayed and/or deleted for example) by other operations that are not realized via operations on the history buttons 109. Other operations include, for example, an operation for accessing image data 33 different from the image data 31 corresponding to the history buttons 109. From another perspective, the other operations include operations performed on buttons (function buttons 107) that are displayed together with the history buttons 109 on the home screen 101.

In the illustrated example, as indicated by the arrows a1, the controller 17 only allows access to the image data 31 corresponding to any of the history buttons 109 through an operation performed on that history button 109. The thumbnail 129 corresponding to the accessed image data 31 is then displayed. From another perspective, the controller 17 does not display the image data 31 (and the image data 33 of the box function and so on) corresponding to the other history buttons 109 when accessing the corresponding image data 31 via that particular history button 109.

However, unlike in the illustrated example, the controller 17 may access other pieces of image data 31 (or 33) via the history buttons 109 and display the accessed pieces of image data. For example, image data other than the corresponding image data 31 may be selected as a new target of image processing by double-tapping on the thumbnail 129.

Unlike in the illustrated example (arrow a3), the controller 17 may allow access to the image data 33 via operations on the history buttons 109. An example of such a case is, for example, executing image processing based on the image data 33 using the image processing conditions corresponding to the relevant history button 109. For example, on the history use screen 121, a screen or window that allows viewing and selecting one or more pieces of image data 33 may be displayed by performing a prescribed operation on the thumbnail 129 or a button that is not illustrated.

### 1.6. Configuration of Data Relating to History Buttons

FIG. 6 is a schematic diagram illustrating an example configuration of data stored in the storage unit 13 in order to realize the operations described above.

The storage unit 13 may include the following tables or databases for example. A history table 41 that holds information about image processing performed in the past. An image database 43 that holds the image data 31 (previously described) handled in image processing performed in the past. A display table 45 that holds information relating to display of the history buttons 109.

The history table 41 can hold one or more pieces of history information 47. One piece of history information 47, for example, holds information about one image processing operation that has been carried out in the past. One piece of history information 47 holds (associates with each other), for example, “history ID” (ID: Identification), “processing information” (processing information 51), and “image data identification information”.

The “history ID” is information automatically assigned by the controller 17 to a piece of history information 47 when the piece of history information 47 is generated, for example, in order to allow multiple pieces history information 47 to be identified. The format of the history ID may be chosen as appropriate. In FIG. 6, “HID1” to “HID3” are illustrated as the contents of the history information 47 for convenience.

The “processing information” (processing information 51) is information about image processing (including information displayed on the settings buttons 131 for example). The specific content of the processing information 51 is illustrated later in FIG. 7. In FIG. 6. for convenience, rows of dots schematically representing strings of characters are illustrated.

The “image data identification information” is information for identifying the image data 31 handled in the image processing corresponding to the history information 47. This allows access to the piece of image data 31 corresponding to the selected piece of history information 47 when one of multiple pieces of history information 47 is selected. The image data identification information may be, for example, information of the address of the corresponding piece of image data 31 or may be an ID associated with the information of the address. In FIG. 6, for convenience, rows of dots schematically representing strings of characters are illustrated.

The image database 43 holds multiple pieces of image data 31. As understood from the above description of the “image data identification information,” the image database 43 may include or not include a table, which is not illustrated, that holds information of the address of a storage area where the image data 31 is stored and the ID associated with the information of the address. Although referred to as a “database” for convenience, the image database 43 may have or not have a specific structure. For example, the image data 31 may be stored by temporarily securing the necessary storage area and the information of the address may be just stored in the image data identification information.

The display table 45 can hold one or more pieces of display information 49, for example. One piece of display information 49 corresponds to one history button 109, for example. One piece of display information 49 holds (associates with each other), for example, “order” and “history ID”.

The “order” is, for example, information on the order of the multiple history buttons 109. The information on the order is information on the positions of the history buttons 109 from another perspective. In FIG. 6, for convenience, the order of the timeline region 105 is illustrated as “1” to “3” from the top, “History ID” is the same as described in the description of the history table 41.

For example, when displaying the home screen 101, the controller 17 refers to the display table 45 and identifies the history ID corresponding to the history button 109 at each position. The controller 17 refers to the history table 41 and identifies the processing information 51 associated with the identified history ID. The controller 17 then displays at least part of the identified processing information 51 in the corresponding history button 109.

When any of the history buttons 109 on the home screen 101 is selected, for example, the controller 17 refers to the display table 45 and identifies the history ID corresponding to the selected history button 109. The controller 17 then refers to the history table 41 and identifies the processing information 51 associated with the identified history ID. The controller 17 then displays at least part of the identified processing information 51 in the settings button 131 of the history use screen 121. The results of identifying and reading out the processing information 51 associated with the history ID that was performed when the home screen 101 was displayed may be used here.

When the controller 17 identifies the history ID corresponding to the selected history button 109 as described above, for example, the controller 17 refers to the history table 41 and identifies the image data identification information associated with the identified history ID. The controller 17 then accesses the corresponding image data 31 based on the identified image data identification information and displays the thumbnail 129. The identification and reading out of the image data identification information associated with the history ID may be performed when the home screen 101 is displayed.

For example, when any of the use buttons 123 is selected and a prescribed operation is performed with the execute button 125, the controller 17 performs the image processing selected by the use button 123 based on the image data 31 accessed as described above. In contrast to the above description, when the execute button 125 is operated, access to the image data 31 based on the image data identification information may be performed again, or when a prescribed operation is performed on the execute button 125 without the thumbnail 129 being displayed, access to the corresponding image data 31 may be performed for the first time.

As mentioned in the description of FIG. 4, the image data 31 (image database 43) may be stored in either volatile memory or nonvolatile memory. In a case in which the image data 31 is stored in volatile memory, for example, the history table 41 may also be stored in volatile memory. In a case in which the image data 31 is stored in nonvolatile memory, for example, the history table 41 may also be stored in nonvolatile memory. From another perspective, the image data 31 and the history information 47 may be deleted at the same time.

The display table 45 may maintain or not maintain continuity before and after the power is turned on and off (or before and after sleep mode). In the latter case, for example, when the power is turned on (or when the device returns from sleep mode), the controller 17 may generate display table 45 by referring to the history table 41. As understood from this description, the display table 45 may be stored in either volatile memory or non-volatile memory, regardless of whether the image database 43 and the history table 41 are stored in volatile memory or non-volatile memory.

FIG. 6 is merely an example and is a conceptual diagram. Therefore, the manner in which the various types of information are stored may differ from that described above. For example, in the example in FIG. 6, the history table 41 and the image database 43 are separate from each other, but a database having a specific structure that stores both the history table 41 and the image database 43 may be constructed. In this case, the image data identification information may no longer be required, for example, if the processing information 51 and the image data 31 are stored in contiguous storage areas. For example, similarly, the history table 41 and the display table 45 may be merged together.

FIG. 7 is a schematic diagram illustrating an example of the contents of the information held in one piece of processing information 51.

The processing information 51 may, for example, hold information on the “type” of image processing, “processing conditions”, “processing date and time”, “user name”, and “communication destination” in association with each other. Note that depending on the type of image processing, there may be irrelevant information (for example, “communication destination” when the “type” is copying). In such a case, for example, no information may be stored in the storage area corresponding to the irrelevant information, or information indicating that the information is irrelevant may be stored in the storage area. Alternatively, different data structures may be used for the processing information 51 depending on the type of image processing, such that storage areas corresponding to irrelevant information are not reserved.

For example, “image quality” and “layout” information may be stored as “processing conditions” information. These specific pieces of information include, for example, those illustrated in the settings buttons 131 in FIG. 3. For example, “image quality” information may include “color/black & white” and “density” information. “Layout” information may include “paper selection”, “enlarge/reduce”, “page collation”, and “double sided”.

### 1.7. Example of Procedure of Processing Executed by Image Processing Device

FIGS. 8 and 9 are flowcharts illustrating examples of the procedures of processing executed by the controller 17 in order to realize the operations of the image processing device 1 described above. This processing is initiated, for example, when the power of image processing device 1 is turned on (or when restored from sleep mode).

In FIG. 8, generally speaking, an example of the processing procedure for when image processing is performed in response to an operation performed on any of the function buttons 107 on the home screen 101 is illustrated. FIG. 9 illustrates, generally speaking, an example of the processing procedure for when image processing is performed in response to an operation performed on any of the history buttons 109.

In Step ST1 (FIG. 8), the controller 17 displays the home screen 101 on the operation panel 9.

In Step ST2, the controller 17 determines whether or not execution of image processing has been instructed. For example, as previously mentioned, an instruction for executing image processing is given by tapping any of the function buttons 107 and then tapping the execute button displayed on the screen (or window) that is displayed afterwards. The controller 17 then proceeds to Step ST3 in the case of a positive determination, and to Step ST11 in FIG. 9 via a symbol F1 illustrated in FIG. 8 and FIG. 9 in the case of a negative determination.

In Step ST3, the controller 17 starts the image processing that has been instructed to be performed.

In Step ST4, the controller 17 determines whether or not the image processing that was instructed to be performed has been completed. The controller 17 then proceeds to Step ST5 in the case of a positive determination, and proceeds to Step ST9 in the case of a negative determination.

In Step ST5, the controller 17 updates the history table 41 illustrated in FIG. 6. For example, new history information 47 is generated based on the information about the current image processing, and the generated history information 47 is added to the history table 41. If the number of pieces of history information 47 has reached the upper limit (for example, the same value as the upper limit of history buttons 109 that can be displayed), the history information 47 having the oldest processing date and time is deleted. The processing date and time included in the history information 47 may be that at an appropriate time such as at the time of a positive determination in Step ST2, at the time of a positive determination in Step ST4, or at the time when the history table 41 is updated in Step ST5.

In Step ST6, the controller 17 updates the image database 43 illustrated in FIG. 6. For example, the image data 31 for the current image processing is added to the image database 43. When history information 47 is to be deleted as described above, the image data 31 corresponding to the history information 47 to be deleted is also deleted.

In Step ST7, the controller 17 updates the display table 45 illustrated in FIG. 6. For example, the correspondence between the order and the history ID is changed so that the order associated with the history ID is moved down by one. If the number of history IDs has reached the upper limit (corresponding to the upper limit of history buttons 109 that can be displayed) prior to moving down, the history ID with the bottommost order is deleted. The history ID for the current image processing (the history ID assigned to the history information 47 generated in Step ST5) is then associated with the topmost order.

FIG. 8 is conceptual diagram for facilitating understanding. Therefore, for example, in reality, Steps ST5 to ST7 may be performed in a procedure that cannot be divided as described above. In addition, the order of Steps ST5 to ST7 may be different from that described above.

In Step ST8, the controller 17 determines whether a completion condition has been satisfied. The completion condition may be, for example, that an operation is performed on a physical button, which is not illustrated, that instructs the power to be turned off (or to go into sleep mode). The controller 17 then returns to Step ST1 in the case of a negative determination, or terminates the main processing in FIG. 8 in the case of a positive determination.

In Step ST9, the controller 17 determines whether or not any abnormalities have occurred with respect to the image processing that was instructed to be performed. In the case of a negative determination, the controller 17 returns to Step ST3 and continues the image processing. On the other hand, in the case of a positive determination, the controller 17 proceeds to Step ST10.

There are different types of abnormalities in different types of image processing. For example, there are paper jams in copying or printing, document jams in copying, scanning. faxing, or emailing, and communication errors in faxing or emailing.

In Step ST10, processing is performed in accordance with the abnormality. In this case, the content of the processing and the steps to be followed after the processing may be set as appropriate in accordance with the type of abnormality.

For example, if the abnormality is a paper or document jam, the controller 17 displays an image on the operation panel 9 instructing the user to clear the jam. Once the abnormality has been resolved, the controller 17 returns to Step ST3 (this path is not illustrated in FIG. 8).

In addition to (or instead of) displaying an instruction to resolve the abnormality, for example, the controller 17 can also accept cancellation (or pausing. The same applies hereafter) of the image processing via the operation panel 9). In the case of cancellation, the controller 17 skips Steps ST5 to ST7, for example, and proceeds to Step ST8 or ST1 (this path is not illustrated in FIG. 8).

In the case of cancellation as described above, depending on the type of abnormality, data relating to the image processing (image data 31) may have been acquired at the stage of Step ST10. For example, if the abnormality is a paper jam in copying or printing, the data of the image to be printed is stored in the storage unit 13 (for example, RAM). In this case, unlike in the above description, the controller 17 may proceed to Step ST5 (illustrated example).

For example, if the abnormality is a communication error in faxing or emailing, the controller 17 displays on the operation panel 9 that abnormality termination will be carried out because a communication error has occurred. In this case, the controller 17 may proceed to Step ST5 (illustrated example) or skip Steps ST5 to ST7 and proceed to Step ST8 or ST1.

In Step ST11 (FIG. 9), controller 17 determines whether or not a prescribed operation has been performed on a history button 109 on the home screen 101. The controller 17 then proceeds to Step ST12 in the case of a positive determination, and proceeds to Step ST17 in the case of a negative determination.

In Step ST12, the controller 17 accesses the history information 47 and image data 31 corresponding to the history button 109 selected in Step ST11. The operations performed at this time are as described in the description of the configuration of the data in FIG. 6 and FIG. 7.

In Step ST13, the controller 17 displays the history use screen 121 based on the history information 47 and image data 31 accessed in Step ST12.

In Step ST14, the controller 17 determines whether or not changes to the settings of the conditions of image processing have been instructed via the operation panel 9. For example, as previously mentioned, an instruction to change settings of the processing conditions is given by tapping one of the settings buttons 131 and performing a prescribed operation on the screen (or window) that appears thereafter. The controller 17 then proceeds to Step ST15 in the case of a positive determination, or skips Step T15 and proceeds to Step ST16 in the case of a negative determination.

In Step ST15, the controller 17 changes the settings of the conditions for the image processing that is going to be performed based on the instruction in Step ST14.

In Step ST16, the controller 17 determines whether or not execution of image processing has been instructed. The instruction to execute image processing is made, for example, by tapping the execute button 125 with any of the use buttons 123 selected, as previously described. The controller 17 then proceeds to Step ST3 in FIG. 8 via a symbol F2 illustrated in FIG. 8 and FIG. 9 in the case of a positive determination, and returns to Step ST14 in the case of a negative determination.

Illustration of the procedure for returning to the home screen 101 via the return button 133 is omitted from FIG. 9.

In Step ST17, the controller 17 performs other processing (or substantially no processing.). Other processing includes, for example, processing for pre-registered users to log in (see Second Embodiment) and processing for connecting the image processing device 1 to other devices via a virtual private network (VPN). The controller 17 then proceeds to Step ST8 in FIG. 8 via a symbol F3 illustrated in FIG. 8 and FIG. 9.

### 1.8. Summary of First Embodiment

As described above, the image processing device 1 may include the operation panel 9, the storage unit 13, and the controller 17. The operation panel 9 may accept instructions from a user regarding image processing and may be capable of displaying multiple history buttons 109 containing information about image processing completed in the past. The storage unit 13 may store image data 31 handled in past image processing. The controller 17 may allow access to corresponding image data 31 in the storage unit 13 via the displayed history buttons 109 under the condition that the history buttons 109 can be displayed on the operation panel 9.

Thus, for example, as already mentioned, image data 31 handled in the past can be easily used in new image processing. For example, after performing copying, the same image can be reprinted without needing to scan the document again. As a result, user convenience is improved. The history buttons 109 can contain information about image processing that has been “completed” in the past and allow access to the image data 31 that corresponds to that information. In known image processing devices, image data that has been temporarily stored in RAM for the purpose of performing image processing cannot be accessed because the image data is deleted once the image processing is completed.

The information about image processing displayed on the history buttons 109 may include text or symbol images relating to at least one out of the type of image processing. processing conditions, date and time of processing, user name, and communication destination.

In this case, for example, the user can easily ascertain the history from the history buttons 109. This in turn facilitates access to image data 31 completed in the past via the history buttons 109. In other words, user convenience is improved. Since the text or symbol image displayed on a history button 109 is “related” to the user name, for example, even if the user name is defined as a string of characters, a graphic associated with the user name (user) by the user or image processing device 1 may be displayed on the history button 109.

The processing conditions displayed on the history buttons 109 may include at least one out of image quality and page layout.

In this case, for example, the history can be easily checked when searching for optimal processing conditions by repeatedly performing printing based on the same image data while varying the image quality and page layout. As a result, selecting the history button 109 that was considered the best at a later time and performing printing again under those processing conditions is facilitated.

The image data 31 that can be accessed via the history buttons 109 may be image data that has been handled in the past in image processing corresponding to any out of copying, scanning, and printing.

In this case, for example, the history buttons 109 can be used for functions that are frequently used in a multifunction machine.

The controller 17 may allow the image data 31 accessed via the history buttons 109 to be used in new image processing.

In contrast to the above, an example of a mode in which image data 31 is not used in new image processing is a mode in which image processing based on image data 33 of the box function is performed using processing conditions set in image processing selected using any of the history buttons 109 (processing conditions retained in the history information 47), and the past image data 31 is only used to check the history via display of the thumbnails 129 (such a mode may also be included in technologies relating to the present disclosure). Compared to this mode, as already mentioned, image processing based on image data handled in the past can be conveniently executed via the history buttons 109. From another perspective, operations that can be performed can be made more varied through selection of the history buttons 109.

The controller 17 may allow the image data 31 accessed through the history buttons 109 to be used in different types of image processing from the types of image processing displayed in the history buttons 109.

In this case, for example, the history buttons 109 can be used to easily execute various types of image processing on the same image, and user convenience is improved. In addition, for example, redundant operations can be omitted to reduce the burden on the user and/or the image processing device 1. More precisely, for example, after “copying” has been performed using the relevant function button 107, “printing”, “sending by fax”, “sending by email” and/or “saving to box” (or scanning, from another perspective) can be performed using the use buttons 123 without having to reset the document. Furthermore, the processing conditions of the original image processing can sometimes be applied to the new image processing (for example, “copying” and “printing” are at least partially compatible in terms of processing conditions). This also improves convenience.

The controller 17 may allow image data 31 accessed via the history buttons 109 to be used in image processing that is the same type of image processing as displayed on the history buttons 109 under different processing conditions.

The term “same type” used here may mean, for example, the same combination with or without various operations such as scanning, printing, sending faxes, receiving faxes, sending emails, receiving emails, and so on. For example, “copying” and “printing” differ from each other because only the former includes “scanning”. The “print” function button 107 is for performing printing based on image data stored in a storage medium, which is not illustrated, connected to the image processing device 1, whereas the “print” use button 123 is for performing printing based on the image data 31 stored in the storage unit 13. Although the image data is stored in different devices in these operations, only printing is performed in both operations and therefore the operations may be considered to be the same type of image processing. Printing based on image data selected via the “box” function button 107 may also be considered to be the same type of image processing as the “print” function button 107 and the “print” use button 123.

When the same type of image processing is performed with different processing conditions as described above, the image processing can be easily repeated, for example. when a mistake is made regarding the setting of processing conditions, or when the results of the executed image processing are not what was expected. For example, if “color” printing was intended to be performed but the default setting was “black & white”, printing can be conveniently carried out again. In addition, for example, if the density and/or size of a printed image is not what was expected, the image can be easily re-printed with a different density and/or size.

The image data 31 in the storage unit 13 may be deleted from the storage unit 13 when the corresponding history button 109 is no longer able to be displayed.

In this case, for example, the possibility of unwanted access to the image data 31 is reduced and security is improved.

When corresponding image data 31 inside the storage unit 13 is accessed via the appropriate history button 109 on the operation panel 9, the other image data 31 stored in storage unit 13 may be hidden on the operation panel 9. For example, the history use screen 121 displays the thumbnail 129 based on the corresponding image data 31, but does not display thumbnails 129 based on other image data 31.

In this case, for example, the correspondence between the history buttons 109 and the image data 31 is easy to ascertain. As a result, for example, the convenience of users who are unfamiliar with the operation of the image processing device 1 is improved.

### Second Embodiment

In the description of the Second Embodiment, basically, only the differences from the First Embodiment will be described. Matters that are not specifically mentioned may be the substantially the same as in the First Embodiment or may be inferred from the First Embodiment.

As already mentioned, the Second Embodiment differs from the First Embodiment in that a function for authenticating users is assumed. However, the Second Embodiment may be viewed as a sub-concept of the First Embodiment. Therefore, the symbols and so on referring to the components are the same in both embodiments.

In the description of the Second Embodiment, for convenience, the maximum number of history buttons 109 that the timeline region 105 can contain (the maximum number of history buttons 109 that can be displayed) may be expressed as though the number is the same as the number of history buttons 109 that are displayed in the timeline display region 101b. In other words, the timeline region 105 may be represented as though the entire timeline region 105 is displayed in the timeline display region 101b.

Hereafter, the image processing device 1 according to the Second Embodiment will be briefly described in the following order.
2.1. Identification Information, Authentication Method, and Authorization
2.2. Display Examples of History Buttons 109 (FIGS. 10 to 12)
2.3. Example of Accessibility to Image Data 31 (FIGS. 13 to 15)
2.4. Example of Data Configuration (FIGS. 16 to 18)
2.5. Example of Procedure of Processing Executed by Image Processing Device (FIGS. 19 and 20)
2.6. Summary of Second Embodiment

### 2.1. Identification Information, Authentication Method, and Authorization

Identification information identifying a user may be, for example, the “user name” illustrated as information about image processing in the description of the First Embodiment. In the First Embodiment, the user name was used as information displayed to allow the user to identify or confirm the history buttons 109. In this embodiment, furthermore, the image data 31 that is allowed to be accessed or the history button 109 (from another perspective, the history information 47) that is displayed may differ depending on the user who is logged into the image processing device 1.

The “user name” may be, for example, a string of characters set by the user or the administrator of the image processing device 1. The image processing device 1 may allocate another type of identification information to the user name and store the two types of information together, and this would allow the database searches and so on to be performed using another type of identification information. In other words, identification information used externally (user name) may be different from identification information used internally. However, since the two types of identification information may be viewed as being conceptually identical, the user name will be described as being used internally in this embodiment.

Authentication is an operation for checking whether or not a user who is attempting to use the image processing device 1 (attempting to log into the image processing device 1) is a pre-registered user (from another perspective, a user who is associated with a user name). The authentication method may be any one of various methods, for example, a known method.

For example, authentication may be performed by entering a user name and a password via the operation panel 9. In the description of this embodiment, this mode will be primarily used as an example. For example, the authentication may be biometric authentication performed based on a user's biometric information detected by a detection unit, which is not illustrated, of the image processing device 1. Biometric information includes, for example, a fingerprint or an iris. In addition, for example, the authentication may be card authentication performed based on communication between a card reader, which is not illustrated, of the image processing device 1 and an integrated circuit (IC) card of the user. Card authentication may be static authentication or dynamic authentication. Authentication may be performed based on information read out from a storage medium (for example, a USB memory) connected to a connector, which is not illustrated, of the image processing device 1. For example, the authentication may be performed based on communication between the communication unit 7 of the image processing device 1 and a terminal (for example, mobile terminal) of the user.

Note that among the authentication methods described above, except for authentication via the communication unit 7, the authentication methods are methods in which authentication is performed via the action of user input made to a user interface unit (for example, the operation panel 9, a detection unit for biometric information, a card reader, or a connector) of the image processing device 1. In addition, input of the user name can be omitted in the authentication methods described above, with the exception of password authentication.

The substantive part of the authentication (for example, verification) may be performed by the image processing device 1 itself (for example, an authentication management unit 19 illustrated in FIG. 10 described below). However, the image processing device 1 may transmit authentication information to a server, which is not illustrated, via the communication unit 7, allow the server to perform verification, and use the results to grant authorization to the user. In other words, the image processing device 1 (authentication management unit 19 only needs to grant authorization based on the results of user authentication, and does not need to perform user authentication itself. In the description of this embodiment, for convenience, the image processing device 1 may be assumed to perform authentication. So long as no contradictions or the like arise, the term “image processing device 1” or “authentication management unit 19” may be replaced by the term “server” with respect to authentication.

The description of the First Embodiment mentions that a history button 109 may be added for image processing that is performed by transmitting a signal including a print job or the like from another device (for example, a PC) to the communication unit 7. In this mode as well, authentication may be performed using various methods in which authentication is performed via communication between electronic devices, for example. For example, authentication may be performed using a user name and password, authentication may be performed by transmitting biometric information to the image processing device 1, or a static key, a private key, a public key, and/or a digital certificate may be used.

The user names and authentication information (for example, passwords or biometric information) are stored in the database of the image processing device 1 (or server) in association with each other in advance, for example, by operations performed by an administrator or individual users of the image processing device 1. When an operation for authentication is performed by a user, the image processing device 1 refers to the database in order to perform authentication.

In the following description, a user who has been successfully authenticated may be referred to as an authenticated user for convenience. In addition, users who have not been authenticated are also sometimes referred to as guest users. A pre-registered user who can become an authenticated user is sometimes referred to as a registered user. The image processing device 1 may allow or not allow the use of the image processing device 1 by guest users. In the description of this embodiment, the former case is basically taken as an example.

The image processing device 1 may display a screen (or window) requesting the user to undergo authentication before displaying the home screen 101 so that the home screen 101 is operable, or may display a function button 107 for performing authentication on the home screen 101. In the former mode, the screen that requests the user to undergo authentication may display a button allowing selection of a guest user. For example, when guest user is selected in the former mode, when authentication is not performed via the function button 107 in the latter mode, and when authentication fails in the former mode and latter mode, the image processing device 1 operates with the assumption that the user using the image processing device 1 is a guest user.

The image processing device 1 may perform different operations when the user using the image processing device 1 is an authenticated user and when the user using the image processing device 1 a guest user. In addition, the image processing device 1 may perform different operations for different authenticated users. From another perspective, the image processing device 1 may grant authorization for image processing to each user based on the results of user authentication. Authorization for image processing may be broadly interpreted such as whether access to image data 31 is permitted.

Examples of different authenticated users include different users having the same authorization level as each other and users having different authorization levels from each other. In this embodiment, description of differences in operation due to differences in authorization level is basically omitted. In other words, in this embodiment, the differences between a case where the user is an authenticated user and a case where the user is a guest user are mainly described. As an authenticated user, basically, a general authenticated user is assumed rather than an authenticated user having a high authorization level.

### 2.2. Display Examples of History Buttons

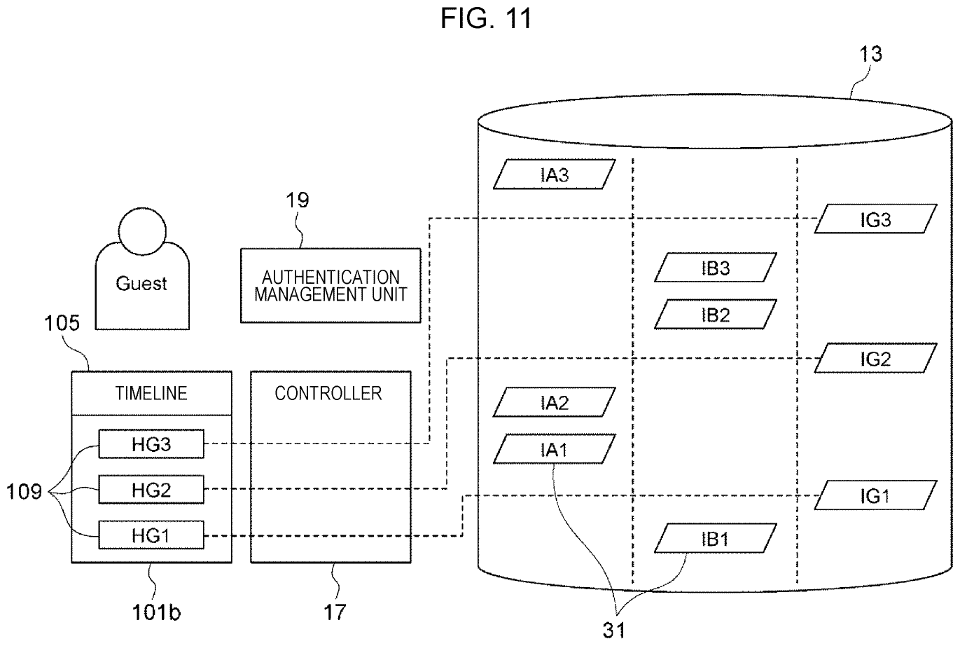

Hereafter, display examples of the history buttons 109 according to the Second Embodiment will be briefly described in the following order.
2.2.1. First Display Example (FIGS. 10 and 11)
2.2.2. Second Display Examples (FIG. 12)

### 2.2.1. First Display Example

FIG. 10 is a schematic diagram illustrating a display example of the history buttons 109 for when a user is an authenticated user (“user A” in the illustrated example).

In this example, in short, when the user A has been successfully authenticated, the history buttons 109 are displayed on the operation panel 9 only for image processing that the user A has performed in the past as an authenticated user. In other words, the history buttons 109 for image processing performed by other authenticated users and guest users are not displayed. FIG. 10 displays this situation in a schematic manner.

In FIG. 10, the following are given as examples of the image data 31 stored by the storage unit 13. Image data relating to image processing performed by the user A as an authenticated user in the past (“IA1” to “IA3”). Image data relating to image processing performed by a user B as an authenticated user in the past (“IB1” to “IB3”). Image data relating to image processing performed by guest users in the past (“IG1” to “IG3”).

In FIG. 10, the higher up the pieces of image data 31 are positioned, the more recent their processing dates and times. In other words, the image data 31 consist of “IA3”, “IG3”, “IB3”, “IB2”, “IG2”, “IA2”, “IA1”, “IG1”, and “IB1” in order from newest to oldest.

The timeline region 105 includes the history buttons 109 (“HA1” to “HA3”) corresponding to the image data 31 of the user A. The multiple history buttons 109 are arranged in order of the processing dates and times. In other words, from top to bottom, the timeline region 105 includes “HA3” corresponding to “IA3”, “HA2” corresponding to “IA2”. and “HA1” corresponding to “IA1”.

For such a display: the authentication management unit 19 of the image processing device 1 authenticates the user and grants the user authorization for image processing. The authentication management unit 19 is an example of various functional units realized by the CPU 11 (FIG. 1) executing a program stored in the storage unit 13 (for example, in ROM and/or auxiliary storage device). The granting of authorization may correspond to an operation of setting a prescribed flag, for example, inside the image processing device 1. The controller 17 then refers to the above flag and performs the above display for the authorized user (i.e., authenticated user).

Although not specifically illustrated, the display mode when the user B, who is not illustrated, has been authenticated is substantially the same as in FIG. 10. In other words. history buttons 109 corresponding to the image data 31 “IB3”, “IB2”, and “IB1” are displayed in this order in the timeline region 105.

FIG. 11 is a schematic diagram illustrating a display example of the history buttons 109 when the user is a guest user.

In this example, simply put, the operation panel 9 displays the history buttons 109 only for image processing that guest users have performed in the past. In other words, the history buttons 109 for image processing performed by authenticated users are not displayed. FIG. 11 displays this situation in a schematic manner.

In FIG. 11, the image data 31 stored by the storage unit 13 is the same as in FIG. 10. The timeline region 105 includes the history buttons 109 (“HG1” to “HG3”) corresponding to the image data 31 of the guest users. The multiple history buttons 109 are arranged in order of the processing dates and times. That is, from top to bottom, the timeline region 105 includes “HG3” corresponding to “IG3”, “HG2” corresponding to “IG2”, and “HG1” corresponding to “IG1”.

With respect to the display examples in FIGS. 10 and 11, deletion of the image data 31 described with reference to FIG. 4 and so on may be performed on a per-user basis, for example. For example, when the number of pieces of image data 31 for each user (each registered user or guest user) exceeds the maximum number of history buttons 109 that can be contained in the timeline region 105 (three in the illustrated example), the oldest piece of image data 31 out of the image data 31 of that user may be deleted. In other words, the total number of pieces of image data 31 of multiple users may exceed the maximum number of history buttons 109. The maximum number of history buttons 109 may be different for authenticated users and guest users, or for each authenticated user.

### 2.2.2. Second Display Example

FIG. 12 is a schematic diagram illustrating a different display example of the history buttons 109 from that in FIG. 10 for when the user is an authenticated user (“user A” in the illustrated example).

In this example, simply put, when the user A has been successfully authenticated, the operation panel 9 displays the history buttons 109 for image processing performed by all users in the past. FIG. 12 displays this situation in a schematic manner.

In FIG. 12, the image data 31 stored by the storage unit 13 is the same as in FIG. 10. The timeline region 105 contains the history buttons 109 corresponding to the image data 31 of all the users within the range of the maximum number of history buttons 109 that can be displayed. The multiple history buttons 109 are arranged in order of the processing dates and times. That is, from top to bottom, the timeline region 105 includes “HA3” corresponding to “IA3”, “HG3” corresponding to “IG3”, and “HB3” corresponding to “IB3”. From another perspective, the history buttons 109 corresponding to other image data 31 (for example, a history button 109 corresponding to “IA2”) are not displayed.

Although not specifically illustrated, unlike in the example in FIG. 12, when the user A is successfully authenticated, the history buttons 109 may be displayed for two or more users, including the user A, which constitute a portion of all the users. For example, the image processing device 1 may operate so as to display only the history buttons 109 for all authenticated users and not display the history buttons 109 for guest users. For example, the image processing device 1 may possess a table in which individual users are associated with user groups and may display the history buttons 109 for all users in the user group to which the user A belongs.

The image processing device 1 may present only the display mode in FIG. 12 to the user A, or may selectively present the display mode in FIG. 10 and the display mode in FIG. 12 to the user A depending on a selection made by the user A. In the case where the authenticated user is the user B, the display mode may be the same as that for the user A, or only the display mode in FIG. 10 may be presented. In the latter implementation mode, the user A and the user B may be registered users having different levels of authorization.

In an implementation mode in which the display mode in FIG. 12 is presented to the user A, the display mode presented to a guest user may be that in FIG. 11, may be that in FIG. 12, or the display mode in FIG. 11 and the display mode in FIG. 12 may be selectively presented depending on a selection made by the guest user.

When the display mode of FIG. 12 is presented, deletion of image data 31 may be performed as appropriate. For example, as in FIGS. 10 and 11, deletion of the image data 31 described with reference to FIG. 4 and so on may be performed for each user. Such a mode is exemplified in FIG. 12, and the number of pieces of image data 31 for each user is the same as the maximum number of history buttons 109 (three in the illustrated example).

Assuming that only the display mode in FIG. 12 is presented to the user A (authenticated user, registered user) (the display mode in FIG. 10 is not presented), the storage unit 13 in the figure also stores the image data 31 (for example, “IA2” and “IA3”) for which the history is not displayed on the history buttons 109. Thus, history does not necessarily need to be displayable on the history buttons 109 for image data 31 stored in the storage unit 13. This also applies to the image data 31 of other users.

However, in the above mode as well, the image data 31 may be at least automatically deleted in order from oldest to newest as image processing is performed. That is, when the number of pieces of image data 31 for each user exceeds a prescribed number (for example, any number greater than or equal to the maximum number of history buttons 109), the oldest piece of image data 31 for that user may be automatically deleted.

In contrast to the illustrated example, only image data 31 for which the history can be displayed on the history buttons 109 may be stored in a mode in which only the display mode in FIG. 12 is presented to the user A. For example, in an implementation mode in which the display mode in FIG. 12 is presented to all the users, only the image data 31 “IA3”, “IG3”, and “IB3” may be stored.

### 2.3. Example of Accessibility of Image Data

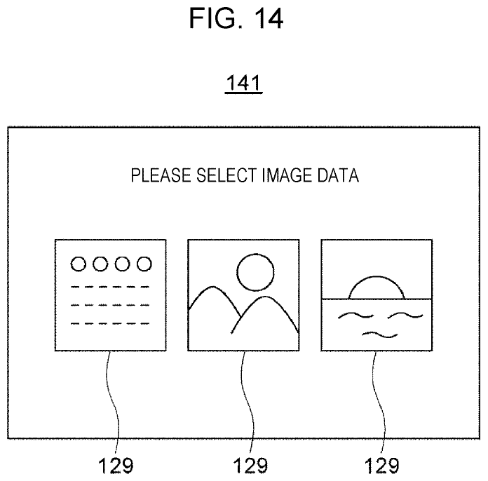

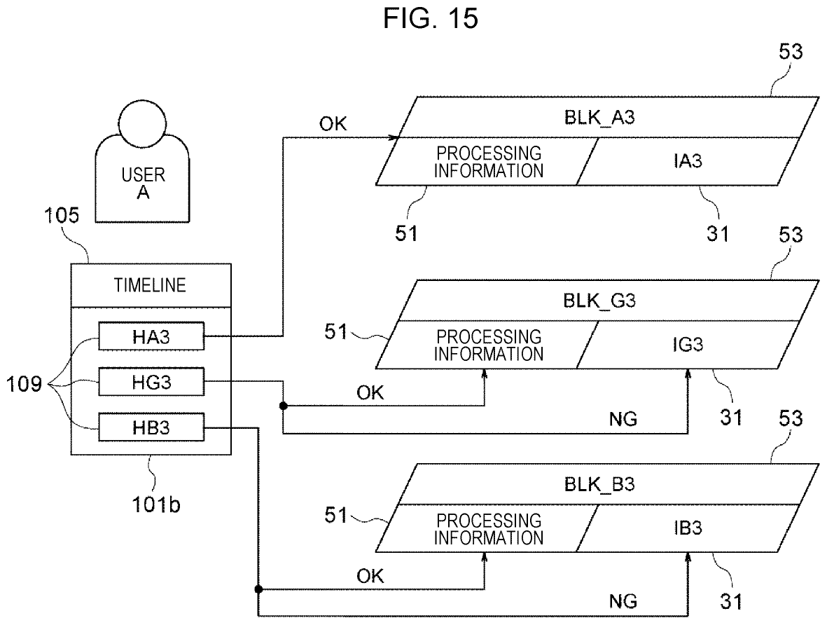

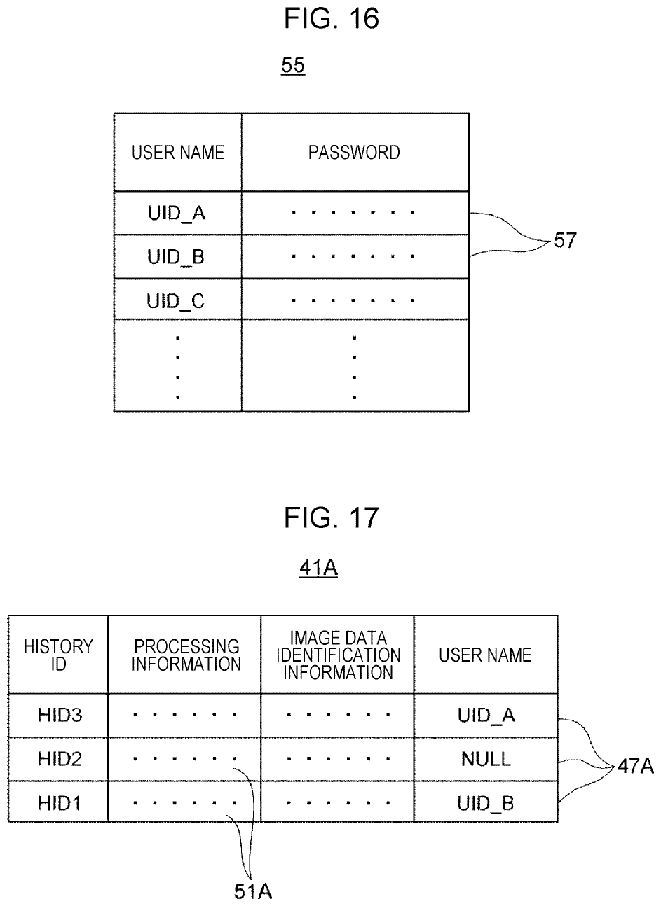

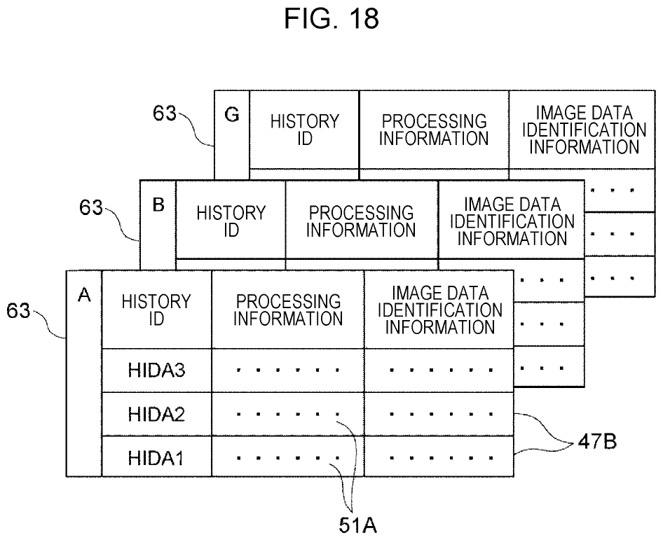

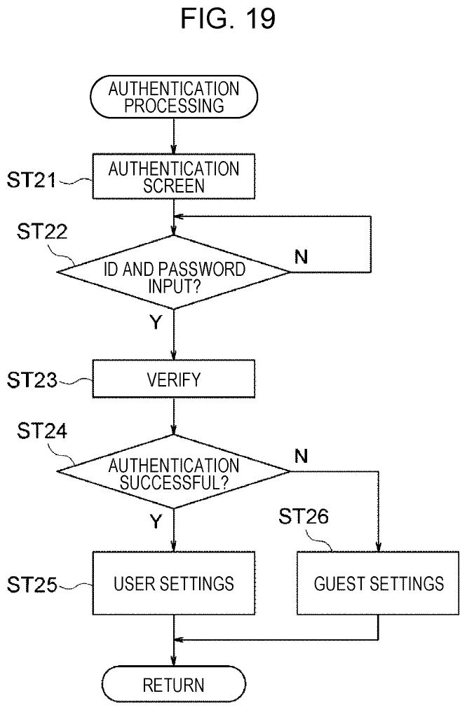

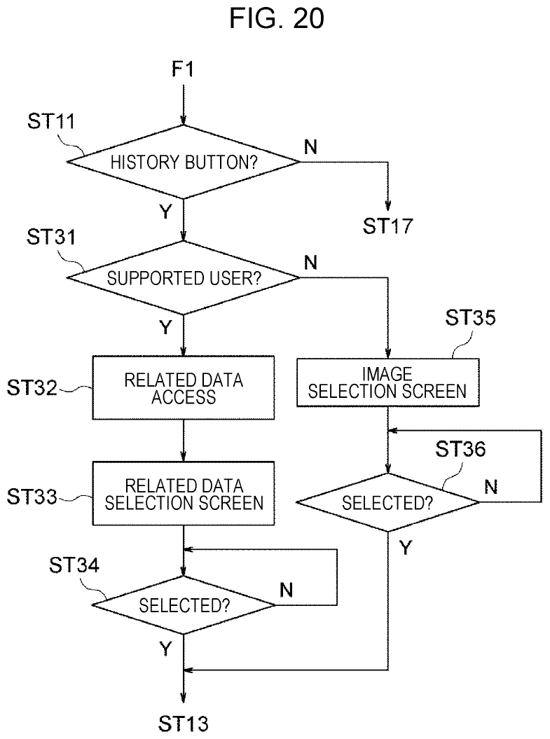

Access to the image data 31 via the history buttons 109 in the Second Embodiment is briefly described below in the following order.
2.3.1. First Access Example (refer to FIG. 5)
2.3.2. Second Access Example (FIGS. 13 and 14)
2.3.3. Third Access Example (FIG. 15)

### 2.3.1. First Access Example

In an implementation mode in which the display modes in FIGS. 10 and 11 are presented, the mode of accessibility to the image data 31 described with reference to FIG. 5 and so on may be applied. In other words, when any of the history buttons 109 is touched. access to the image data 31 (and processing information 51. Hereinafter, the same is true. unless otherwise noted.) associated with the selected history button 109 may be performed.

In this case, for example, as illustrated in FIG. 10, when the user A is logged in and only the history buttons 109 relating to image processing that the user A has performed as an authenticated user are displayed, the user A can only access the image data 31 of the user A. Similarly, the user B, for example, can only access the image data 31 of the user B via the history buttons 109 relating to the history of the user B. A guest user can, for example, access only the image data 31 of guest users via the history buttons 109 relating to the guest users (FIG. 11).

In an implementation mode in which the display mode in FIG. 12 is presented, the mode of accessibility to the image data 31 described with reference to FIG. 5 and so on may be applied. In other words, each history button 109 may only allow access to the image data 31 associated with that history button 109. In this case, access to image data 31 via history buttons 109 associated with an authenticated user (for example, the user A) may only be allowed to that authenticated user (for example, the user A). Access to image data 31 via history buttons 109 associated with guest users may be allowed for all users, for example.

In contrast to this embodiment, access to the image data 31 via the history buttons 109 associated with an authenticated user (for example, the user A) may be allowed not only for that particular authenticated user, but also for another authenticated user (for example, the user B). In other words, access to the image data 31 via the history buttons 109 for authenticated users may only be not allowed for guest users. In addition, in contrast to this embodiment, access to the image data 31 via the history buttons 109 associated with an authenticated user may be allowed to all users (including guest users).

### 2.3.2. Second Access Example

FIG. 13 is a schematic diagram for describing a second example of accessibility when the display mode in FIG. 12 is presented to the user A.

In this example, similarly to as in the previously described example, the user A is able to access the image data 31 of the user A (“HA3” and so on) via the history button 109 (“HA3”) that corresponds to the user A. The user A cannot access the image data 31 (“IB3” and so on) of the user B via the history button 109 (“HB3”) of the user B. The user A may be able to or not be able to (illustrated example) access the image data 31 of the guest users (“IG3” and so) via the history button 109 (“HG3”) of the guest users.

In the example in FIG. 13, unlike in the previously described example, the user A can access not only the image data 31 (“IA3”) associated with the history button 109 corresponding to the user A via that history button 109, but can also access other image data 31 (“IA2” and “IA1”) of the user A. In this way, for example, in the display mode in FIG. 12, the user can easily access the desired image data 31 when the history button 109 corresponding to the image data 31 that the user wishes to access is difficult to find because that history button 109 is buried under the many history buttons 109 of other users. For the sake of clarity, note that other authenticated users (for example, the user B) and guest users cannot access the image data 31 of the user A via the history buttons 109, for example.

Unlike in the example in FIG. 13, when the user A touches any of the history buttons 109 (including the history buttons 109 of other users), the image processing device 1 may allow the user A to access one or more pieces of image data 31 of the user A. Such an operation is also an operation that allows access to the image data 31 of the user A, which is data of a different image from the image data 31 associated with the history button 109.

In contrast to this embodiment, other authenticated users or all users (including guest users) may be able to access the image data 31 associated with the history button 109 of the user A and other image data 31 of the user A by touching the history button 109 of the user A.

When accessing and using other image data 31 that is different from the image data 31 associated with the history button 109 as described above, the processing information 51 used may be associated with the original image data 31 or may be associated with other image data 31.

FIG. 14 illustrates an example of a screen 141 (or window) displayed on the operation panel 9 when a prescribed operation is performed by the user A on the history button 109 of the user A in the mode of access exemplified in FIG. 13.

The screen 141 displays the thumbnails 129 based on the image data 31 as information representing the two or more pieces of image data 31 associated with the user A. The user A then selects the image data 31 that he/she wants to use for new image processing by performing a prescribed operation (for example, tapping) on any one of the thumbnails 129. Once the image data 31 is selected, the screen of the operation panel 9 transitions to the history use screen 121, for example. The operations after that are as described in the First Embodiment.

Unlike in the illustrated example, when a prescribed operation is performed by the user A on the history button 109 (“HA3”) of the user A, multiple history buttons 109 (“HA1” to “HA3”) of the user A may be displayed in the timeline region 105, similarly to as in FIG. 10. In this way, other image data 31 of the user A may be accessible. However, this is an example of a previously described implementation mode in which the display mode in FIG. 10 and the display mode in FIG. 12 are selectively displayed, and the access mode itself may be viewed as being the same as the first access example.

### 2.3.3. Third Access Example

FIG. 15 is a schematic diagram for describing a third example of accessibility when the display mode in FIG. 12 is presented to the user A.

Each single data block 53 illustrated on the right side of the figure schematically illustrates the data corresponding to one history button 109. For example, each data block 53 contains the corresponding processing information 51 and image data 31. The processing information 51 is as has been described with reference to FIG. 6 and FIG. 7. The data block 53 is a combination of the history information 47 and the image data 31 illustrated in FIG. 6. which is conceptually different from the history table 41 and the image database 43. As mentioned in the description of FIG. 6, the history information 47 and the image data 31 may actually be stored in a data structure such as that illustrated in FIG. 15 (a structure in which image data identification information is omitted).

In FIG. 15, the following are given as examples of the data blocks 53, “BLK_A3”.which contains the image data 31 “IA3” corresponding to the history button 109 “HA3” relating to the user A, “BLK_G3”, which contains the image data 31 “IG3” corresponding to the history button 109 “HG3” relating to a guest user, “BLK_B3”, which contains the image data 31 “IB3” corresponding to the history button 109 “HB3” relating to the user B.

In this mode, the accessibility when the user A operates the history button 109 (“HA3”) of the user A may be the same as in the first access example or the second access example described previously, for example. In other words, the user A may be able to access the data block 53 “BLK_G3” (in other words, both the processing information 51 and the image data 31) corresponding to the history button 109 “HA3”, or the user A may be able to additionally access other data blocks 53 (not illustrated).

When the user A operates the history button 109 (“HG3” or “HB3”) of another user. access to the image data 31 corresponding to that history button 109 may be blocked, whereas access to the processing information 51 corresponding to that history button 109 may be permitted. This allows, for example, image processing using another user's processing conditions (for example, image quality and/or layout) to be performed while increasing the security of the image data 31 of the other user. Although the user A has been used as an example, this similarly applies to other users.

In the history use screen 121 illustrated in FIG. 3, under the assumption that the image data 31 corresponding to a history button 109 is used, the use buttons 123 corresponding to image processing including scanning (for example, “copy” and “scan”) are not displayed. However, in a situation where an assumption that image data 31 corresponding to a history button 109 will be used is not necessarily made, use buttons 123 corresponding to image processing including scanning may be provided.

For the image data 31 (“IG3”) of a guest user, unlike in the illustrated example. authenticated users may be able to access this data, or conversely, access may be blocked for all users.

### 2.4. Example of Configuration of Data

FIG. 16 is a schematic diagram illustrating an example of an authentication table 55 used for authentication (verification).

As previously mentioned, the example used here is a mode in which passwords are used as authentication information. As already mentioned, authentication (verification) may be performed by the image processing device 1, or by a server communicating with the image processing device 1 via the communication unit 7. In other words, the authentication table 55 may be stored or not stored, for example, in the auxiliary storage device (in other words, nonvolatile memory) of the storage unit 13. However, in the description of this embodiment, the former is taken as an example.

The authentication table 55, for example, holds one or more pieces of registration data 57. Each piece of registration data 57 holds a user name and a password. In other words, user names and passwords are stored in association with each other in the authentication table 55. Therefore, the authentication management unit 19 can authenticate users based on whether or not the combination of the user name and password entered via the operation panel 9 exists in the authentication table 55.

The interface for entering a user name and a password may be any appropriate interface. For example, a user name and a password may be input to the image processing device 1 by displaying blank spaces on the operation panel 9 into which to enter the user name and the password and by displaying software keys for selecting the characters. Buttons containing text and/or symbol images for identifying registered users may be listed on the operation panel 9, and when any one of the buttons is selected, a screen or window for entering a password may be displayed together with software keys. Hardware keys may be used instead of software keys.

FIG. 17 is a schematic diagram illustrating an example of data for accessing information corresponding to a user.

A history table 41A illustrated in FIG. 17 is substantially the same as the history table 41 illustrated in FIG. 6. However, in the description of FIGS. 6 and 7, the user name is illustrated as one part of the processing information 51, whereas here, for convenience of explanation, the user name is illustrated as being separate information from the processing information 51A. The history table 41A can hold one or more pieces of history information 47A, for example. One piece of history information 47A holds processing information 51A. image data identification information, and a user name. In other words, these pieces of information are associated with each other.

Similarly to as in the First Embodiment, the image processing device 1 adds new history information 47A to the history table 41A when image processing is performed (Step ST5 in FIG. 8). At this time, the new history information 47A is generated so as to include the user name of the user who instructed that image processing (the currently logged-in user). If the user who instructed the image processing is a guest user, the history information 47A may be generated, for example, so as to include a user name that is preset by the manufacturer of the image processing device 1 as a user name representing a guest user, or so as not to include user name information (expressed as “null” in FIG. 17).

The image processing device 1 (controller 17) can identify and use the history information 47A corresponding to each user by referring to the history table 41A. Furthermore, the image processing device 1 can identify and use the image data 31 corresponding to each user based on the image data identification information in the identified history information 47A. The actual data structure may be modified in various ways similarly to as in the First Embodiment.

FIG. 18 is a schematic diagram illustrating another example of a history table.

In this example, a history table 63 is generated for each user. Each history table 63 can hold one or more pieces of history information 47B. Each of the pieces of history information 47B holds processing information 51A (excluding the user name) and image data identification information. In other words, these pieces of information are associated with each other. There are no substantial differences in the content of the information between the history table 41A in FIG. 17 and the multiple history tables 63 in FIG. 18. The actual data structure may be closer to the example in FIG. 17 or the example in FIG. 18.

### 2.5. Example of Procedure of Processing Executed by Image Processing Device

Hereafter, the procedure of processing performed by the image processing device 1 according to the Second Embodiment will be briefly described in the following order.
2.5.1. Example of Procedure of Authentication Processing (FIG. 19)
2.5.2. Example of Procedure of Processing Relating to History Buttons 109 (FIG. 8. FIG. 9 and FIG. 20)

### 2.5.1. Example of Procedure of Authentication Processing

FIG. 19 is a flowchart illustrating an example of the procedure of processing performed by the image processing device 1 (controller 17 and authentication management unit 19 for user authentication. Note that whether the functional unit performing each procedure is the controller 17 or the authentication management unit 19 is not necessarily clear.

The illustrated authentication processing is performed as an example of other processing in Step ST17 of FIG. 9, for example. In more detail, for example, the home screen 101 displays a login button, which is not illustrated. When the login button is tapped, a determination is made as to whether or not a prescribed operation has been performed on the login button through the negative determination of Step ST2 in FIG. 8 and the negative determination of Step ST11 in FIG. 9. In the case of a positive determination, the authentication processing in FIG. 19 is initiated.

In Step ST21, the image processing device 1 displays a screen (or window) for authentication on the operation panel 9. An example of the screen (not illustrated) that is displayed at this time has already been mentioned in the description of FIG. 16.

In Step ST22, the image processing device 1 determines whether or not a user name (described as ID in FIG. 19 and a password have been entered. The image processing device 1 then proceeds to Step ST23 in the case of a positive determination, or stands by in the case of a negative determination. Although not particularly illustrated, when a return button on the authentication screen displayed in Step ST21 is operated, the subsequent steps may be skipped and the authentication processing in FIG. 19 may be terminated.

In Steps ST23 and ST24, the image processing device 1 verifies the input user name and password against the authentication table 55 in order to confirm their validity. The image processing device 1 then proceeds to Step ST25 if the authentication is successful, or to Step ST26 if the authentication is unsuccessful.

In Step ST25, the image processing device 1 sets various settings so that operations are performed in accordance with an authenticated user as described previously. From another perspective, the image processing device 1 grants the user authorization for image processing.

On the other hand, in Step ST26, various settings are set so that operations are performed in accordance with a guest user as described previously. However, Step ST26 may merely maintain the settings in accordance with the guest user that were set upon logout of an authenticated user (no substantive processing may be performed).

After that, the image processing device 1 completes the authentication processing illustrated in FIG. 19 and proceeds to Step ST8 in FIG. 8 (see symbol F3 in FIG. 8). Thus, the home screen 101 is displayed (Step ST1) and so on with the user logged in.

Although not particularly illustrated, logout may be performed as appropriate. For example, logout may be performed by tapping a logout button, which is not illustrated, on the home screen 101 (the login button may change to a logout button after logging in). And/or the user may be automatically logged out once a certain amount of time has elapsed without any operation being performed on the image processing device 1. Once logout has been performed, various settings may be set, for example, for a guest user.

### 2.5.2. Example of Procedure of Processing Relating to History Buttons

In the Second Embodiment, examples of modes of access to the image data 31 via the history buttons 109 are illustrated for first to third access examples. In the first access example (FIG. 5), for example, only access to the image data 31 corresponding to the history buttons 109 is allowed and each user is able to access only his/her own image data 31. The procedure of the processing in this example is basically the same as in the First Embodiment. In other words, basically, the flowcharts illustrated in FIGS. 8 and 9 may be used.

However, for example, in the display of the home screen 101 in Step ST1, the display is performed so that the first display example (FIG. 10 and FIG. 11) or the second display example (FIG. 12) is realized. In the first display example, only the history buttons 109 corresponding to each user are displayed, and in the first access example, only access to the image data 31 corresponding to the history buttons 109 is allowed. Therefore, only access to the image data 31 corresponding to each user is allowed without needing to determine whether access is allowed or not in Step ST12 and so on.

For example, in the first access example and the second display example, for example, between Step ST11 and Step ST12, whether or not the user associated with the touched history button 109 and the current user (for example, authenticated user) match each other is determined (see Step ST31). If they do match, access to the image data 31 is allowed and the history use screen 121 is displayed (Step ST13). If they do not match, for example, this fact may be displayed and the processing may proceed to Step ST8 in FIG. 8.

Hereafter, an example of the procedure of processing performed by the image processing device 1 is illustrated for the combination of the second access example (FIGS. 13 and 14) and the third access example (FIG. 15). The second access example and the third access example are combined with the second display example (FIG. 12) for example. That is, in Step ST1 in FIG. 8, for example, the history buttons 109 for two or more users may be displayed. The two or more users may be, for example, all users, two or more registered users. or all registered users of a user group to which the authenticated user belongs, as previously described.

FIG. 20 is a flowchart illustrating an example of the procedure of processing for when the history buttons 109 are operated in the Second Embodiment. This processing may be viewed as a variation or sub-concept of Step ST12 in FIG. 9.

Step ST11 is the same as Step ST11 in FIG. 9. In other words, the controller 17 determines whether or not any of the history buttons 109 have been touched. The controller 17 then proceeds to Step ST31 in the case of a positive determination, and proceeds to Step ST17 in FIG. 9 in the case of a negative determination.

In Step ST31, the controller 17 determines whether or not the user associated with the touched history button 109 and the current logged-in user (authenticated user) are the same. The controller 17 then proceeds to Step ST32 in the case of a positive determination. and proceeds to Step ST35 in the case of a negative determination.

In Step ST32, the controller 17 accesses all the image data 31 of the user associated with the history button 109.

In Step ST33, the controller 17 displays the screen 141 illustrated in FIG. 14 on the operation panel 9 based on the image data 31 accessed in Step ST32. In other words, the user is requested to select image data 31.

In Step ST34, the controller 17 determines whether or not image data 31 has been selected. The controller 17 then proceeds to Step ST13 in FIG. 9 in the case of a positive determination, and stands by in the case of a negative determination. In Step ST13, the history use screen 121 is displayed as previously described. In this history use screen 121, for example, the image data 31 (and processing information 51) selected in Step ST34 is used, and the same processing as in the First Embodiment is performed. Although not specifically illustrated, the controller 17 may proceed to Step ST8 in FIG. 8 in response to operation of the return button, which is not illustrated, contained in the screen 141.

In Step ST35, the controller 17 displays a screen requesting the user to select image data to be used in new image processing. The image data at this time may be, for example, image data 33 stored using the box function. The screen at this time may, for example, display thumbnails, such as the screen 141, or may display file names. The screen at this time may be similar to a screen used for selecting files (and folders) on a PC. The image data 31 associated with the current user may be selectable.

In Step ST36, the controller 17 determines whether or not image data has been selected. The controller 17 then proceeds to Step ST13 in FIG. 9 in the case of a positive determination, and stands by in the case of a negative determination. In Step ST13, the history use screen 121 is displayed as previously described. In this history use screen 121, for example, the image data selected in Step ST36 is used, the processing information 51 associated with the history button 109 selected in Step ST11 is used, and substantially the same processing as in the First Embodiment is performed. Although not specifically illustrated, the controller 17 may proceed to Step ST8 in FIG. 8 in response to operation of a return button contained in the screen, which is not illustrated, displayed in Step ST35.

In the flowchart of FIG. 20, the screen 141 for selecting any image data 31 from among one or more pieces of image data 31 corresponding to the logged-in user is displayed (Step ST33) before proceeding to Step ST13 and displaying the history use screen 121. However, image data 31 corresponding to the logged-in user may be selected on the history use screen 121. For example, after Step ST31 (without Steps ST32 to ST34 being performed), the history use screen 121 may be displayed (Step ST13) using the image data 31 (and processing information 51) corresponding to the history button 109 selected in Step ST11. Steps ST32 to ST34 (and ST13 again) may then be performed by tapping the thumbnail 129 or another button.

### 2.6. Summary of Second Embodiment

As described above, the image processing device 1 may further include the authentication management unit 19 that grants authorization for image processing to each user based on the results of user authentication. The controller 17 may allow a user granted authorization by the authentication management unit 19 to access other image data 31 inside the storage unit 13 associated with that user via the history buttons 109 (FIG. 13 and Step ST32).

In this case, for example, as already described, in the display mode in FIG. 12, the desired image data 31 can be easily accessed when the history button 109 corresponding to the image data 31 that the user wishes to access is buried under the many history buttons 109 of other users and is difficult to find. In addition, for example, even if old history buttons 109 of the user A are no longer displayed or are difficult to find due to the addition of the history buttons 109 of other users, the user A can still easily access the image data 31 that he or she handled in the past. In cases where the image data 31 that the user wishes to access is difficult to identify based on the information displayed on the history buttons 109, the screen 141 illustrated in FIG. 14 makes finding the image data 31 desired to be accessed easier.

The controller 17 may be able to display both the history buttons 109 of a user granted authorization by the authentication management unit 19 and the history buttons 109 of another user (FIG. 12). The controller 17 may also not allow access to the corresponding image data 31 in the storage unit 13 associated with another user via the relevant history button 109 (see, for example, an operation when the user A operates “HB3” in FIG. 13 or FIG. 15).

In this case, for example, the security of the image data 31 is improved. In addition. as described with reference to FIG. 15, convenience is improved by allowing access to the processing information 51 of other users while blocking access to the image data 31 of the other users via the history buttons 109 of the other users.

Technologies according to the present disclosure are not limited to the above embodiments and may be implemented in the form of various modes.

For example, when image data corresponding to a history button is accessed via the history button, the image data does not need to be available for different types of image processing and/or different processing conditions. For example, image data corresponding to a history button may be used in the same type of image processing under the same processing conditions. For example, processing conditions corresponding to a history button may be registered as one template of processing conditions by operating the execute button 125 on a screen similar to the history use screen 121 but without the use buttons 123 (in other words, a screen where the image data corresponding to the history buttons is used for the thumbnails 129 (i.e., image processing does not need to be performed via a history button).

Image processing information (excluding image data) corresponding to the history buttons 109 does not need to be used in new image processing. For example, image processing based on image data corresponding to a history button may be performed in accordance with processing conditions set independently of the history. Such processing conditions may be set, for example, by operating the settings buttons provided as the function buttons 107, or may be set on the history use screen, and default values may be set as appropriate.

In the history use screen 121, the thumbnail 129 does not need to be displayed. Image processing may be executed by double-tapping any of the use buttons 123 without providing the execute button 125.

The fact that an authorized user may be allowed access to image data associated with the user via the history buttons in FIG. 13 has been described. The image data at this time is, for example, image data 31 associated with the history button in connection to the copy function. The image data at this time may be, for example, image data stored in connection with another function other than the copy function. At this time, the image processing conditions corresponding to the operated history button may be used in image processing based on that image data.

### REFERENCE SIGNS

1 image processing device,
9 operation panel,
13 storage unit
17 controller,
31 image data,
109 history button.

1. An image processing device comprising:
an operation panel configured to accept an instruction from a user regarding image processing and configured to be capable of displaying multiple history buttons that include information about previously completed image processing;
a storage unit configured to store image data handed in previous image processing; and
a controller configured to allow access to corresponding image data inside the storage unit via a displayed history button, among the history buttons, under a condition that the history button can be displayed on the operation panel.

2. The image processing device according to claim 1,
wherein the information about image processing displayed on the history button includes text or a symbol image related to at least one out of type of image processing, processing conditions, date and time of processing, user name, and communication destination.

3. The image processing device according to claim 2,
wherein the processing conditions include at least one out of image quality and page layout.

4. The image processing device according to claim 1,
wherein image data that can be accessed via the history button is image data handled previously in image processing falling under any one of types of image processing including copying, scanning, and printing.

5. The image processing device according to claim 1,
wherein the controller allows image data accessed via the history button to be used in new image processing.

6. The image processing device according to claim 1,
wherein the controller allows image data accessed via the history button to be used in a different type of image processing than a type of image processing displayed on the history button.

7. The image processing device according to claim 1,
wherein the controller allows image data accessed via the history button to be used in image processing of an identical type to image processing displayed on the history button but performed under different processing conditions from those displayed on the history button.

8. The image processing device according to claim 1,
wherein image data in the storage unit is deleted from the storage unit when the corresponding history button is no longer able to be displayed.

9. The image processing device according to claim 1,
wherein when corresponding image data inside the storage unit is accessed via the history button, the operation panel does not display other image data stored in the storage unit.

10. The image processing device according to claim 1, further comprising:
an authentication management unit configured to grant each user authorization for image processing based on results of user authentication,
wherein the controller allows a user granted authorization by the authentication management unit to access other image data inside the storage unit associated with the user via the history button.

11. The image processing device according to claim 1, further comprising:
an authentication management unit configured to grant each user authorization for image processing based on results of user authentication,
wherein for a user granted authorization by the authentication management unit, the controller allows both the user's own history button and another user's history button to be displayed, and does not allow the user to access corresponding image data inside the storage unit associated with the other user via the history buttons.
